(19) United States
(12) Patent Application Publication
(10) Pub. No.: US 2005/0036711 A1
(43) Pub. Date: Feb. 17, 2005

(54) Image interpolation apparatus and method, and edge detecting apparatus and method

(75) Inventor: Yuko Abe, Asaka-shi (JP)

Correspondence Address: MCGINN & GIBB, PLLC, 8321 OLD COURTHOUSE ROAD, SUITE 200, VIENNA, VA, 22182-3817, US

(73) Assignee: Fuji Photo Film Co., Ltd., Minamiashigara-shi (JP)

(21) Appl. No.: 10/917,477

(22) Filed: Aug. 13, 2004

(30) Foreign Application Priority Data
Aug. 14, 2003 (JP) 293487/2003
Sep. 17, 2003 (JP) 324567/2003

(51) Int. Cl. G06K 9/32

(52) U.S. Cl. 382/300

(57) ABSTRACT

In cases where an edge is located between two pixels, between which a new pixel is to be interpolated, a boundary is set between the two pixels. In cases where the new pixel is located on one side of the boundary, an interpolating operation is performed by use of a pixel value of at least one pixel, which is located on the one side of the boundary, in order to calculate a pixel value of the new pixel. In cases where the new pixel is located on the other side of the boundary, the interpolating operation is performed by use of the pixel value of at least one pixel, which is located on the other side of the boundary, in order to calculate a pixel value of the new pixel.

### BACKGROUND OF THE INVENTION

1. Field of the Invention

This invention relates to an image interpolation apparatus and method for interpolating a new pixel between pixels, which constitute an image, for use in, for example, processing for enlarging or reducing a size of the image represented by an image signal. This invention also relates to an edge detecting apparatus and method for detecting an edge, which is located between pixels constituting an image. This invention further relates to a computer program for causing a computer to execute the image interpolation method or the edge detecting method. This invention still further relates to a computer readable recording medium, on which the computer program has been recorded.

2. Description of the Related Art

Operations have heretofore been conducted, wherein an image signal, which has been obtained from a photoelectric readout of an image having been recorded on photographic film, or an image signal, which has been obtained from the imaging of an object with an imaging device, such as a digital camera or a portable telephone with camera, is subjected to processing for enlarging or reducing the size of the image represented by the image signal, such that the size of the image may be adapted to the size of a monitor utilized for reproducing the image from the image signal. In particular, services have heretofore been furnished wherein, at the time of sending of the image signal, which has been obtained from the imaging of the object with the portable telephone with camera, as electronic mail, the image signal is subjected to the processing for enlarging or reducing the size of the image represented by the image signal in accordance with the size of the liquid crystal monitor of the portable telephone to which the image signal is to be sent.

The image size enlargement or reduction processing on the image signal is performed with the processing, wherein a new pixel is interpolated between the pixels, which constitute the image represented by the image signal, in accordance with an enlargement scale factor. As techniques for interpolating the new pixel, various techniques, such as a linear interpolation technique, a nearest neighbor interpolation technique, a bilinear technique, and a bicubic technique, have heretofore been known.

However, in cases where the image size enlargement or reduction processing on the image signal is performed with a single technique alone, the problems occur in that an edge area contained in the image is blurred or becomes shaggy. Therefore, there has been proposed a technique for detecting an edge component contained in an image and performing interpolating operations, in which different interpolating operation processes are utilized for the edge area and a non-edge area. (The technique described above is disclosed in, for example, Japanese Unexamined Patent Publication No. 2002-319020.)

In order for the edge to be detected from the image in the technique disclosed in Japanese Unexamined Patent Publication No. 2002-319020, or the like, a Sorbel filter or a Laplacian filter is ordinarily utilized. Each of the Sorbel filter and the Laplacian filter has an odd number of taps, e.g. three taps. With the filtering processing performed by use of the Sorbel filter or the Laplacian filter, a judgment is made as to whether a pixel of interest is or is not a pixel constituting an edge in an image, and the edge in the image is thus capable of being detected.

Also, there has been proposed a signal component interpolating technique in, for example, U.S. Pat. No. 5,467,439. With the proposed signal component interpolating technique, with respect to an array of four adjacent pixels in an image, which four adjacent pixels are arrayed in a form of 2×2 pixels, an absolute value of a difference between pixel values of each set of two adjacent pixels is calculated, and a maximum value of the absolute values of the differences, which have been calculated for a plurality of the sets of two adjacent pixels, and a second maximum value of the absolute values of the differences are calculated. Also, by the utilization of the results of the calculation, a position of an edge in the array of the four pixels and a shape of the edge are presumed. A pixel value of a pixel to be interpolated in the array of the four pixels is thus calculated.

With the proposed signal component interpolating technique, pixels to be utilized for the interpolating operation are selected in accordance with the shape of the edge. Therefore, the interpolating operation is capable of being performed such that a mosaic phenomenon may not occur.

With the aforesaid technique disclosed in Japanese Unexamined Patent Publication No. 2002-319020, the interpolating operations are performed, in which different interpolating operation processes are utilized for the edge area and the non-edge area. However, the known techniques described above are utilized as the interpolating operation processes, and therefore the problems still occur in that the edge area is blurred. For example, in cases where four pixels G1, G2, G3, and G4, which are adjacent in series to one another, have the shape of the profile as illustrated in FIG. 27A, a sharp edge is located between the pixel G2 and the pixel G3. Also, in cases where four pixels G1, G2, G3, and G4, which are adjacent in series to one another, have the shape of the profile as illustrated in FIG. 27B, an edge is located between the pixel G2 and the pixel G3. In the example illustrated in FIG. 27A or FIG. 27B, in cases where a pixel value of an interpolated pixel between the pixel G2 and the pixel G3 is calculated by use of, for example, the linear interpolation technique, a value lying on the straight line connecting the pixel G2 and the pixel G3, which are located in the vicinity of the interpolated pixel, is taken as the pixel value of the interpolated pixel. Therefore, regardless of the presence of the edge between the pixel G2 and the pixel G3, the variation in pixel value in the vicinity of the edge becomes smooth. As a result, the edge area in the image obtained from the image size enlargement or reduction processing becomes blurred.

In cases where the image size enlargement or reduction processing is performed on an image, since a new pixel is to be interpolated between pixels, instead of a judgment being made as to whether an edge in an image is located at a pixel contained in the image, it is necessary that a judgment be made as to whether an edge in an image is or is not located between pixels. However, in cases where the detection of an edge is performed by use of the aforesaid filter having an odd number of the taps as in the cases of the Laplacian filter, a judgment is capable of being made merely as to whether a pixel of interest itself in an image is or is not a pixel constituting the edge in the image, and a judgment is not capable of being made as to whether an edge in the image is or is not located between pixels.

Also, with the aforesaid signal component interpolating technique proposed in U.S. Pat. No. 5,467,439, the position of an edge in the array of the four adjacent pixels in an image, which four adjacent pixels are arrayed in a form of 2×2 pixels, is presumed. However, with the aforesaid signal component interpolating technique proposed in U.S. Pat. No. 5,467,439, wherein only the four adjacent pixels are utilized, it is not always possible to detect the position of an edge accurately.

### SUMMARY OF THE INVENTION

The primary object of the present invention is to provide an image interpolation apparatus, wherein a new pixel is capable of being interpolated such that an edge area in an image may not be blurred.

Another object of the present invention is to provide an image interpolation method, wherein a new pixel is capable of being interpolated such that an edge area in an image may not be blurred.

A further object of the present invention is to provide an edge detecting apparatus, wherein an edge located between pixels constituting an image is capable of being detected accurately.

A still further object of the present invention is to provide an edge detecting method, wherein an edge located between pixels constituting an image is capable of being detected accurately.

Another object of the present invention is to provide an edge detecting apparatus, wherein a shape of an edge is capable of being classified accurately.

A further object of the present invention is to provide an edge detecting method, wherein a shape of an edge is capable of being classified accurately.

A still further object of the present invention is to provide a computer program for causing a computer to execute the image interpolation method or the edge detecting method.

The specific object of the present invention is to provide a computer readable recording medium, on which the computer program has been recorded.

The present invention provides an image interpolation apparatus for interpolating a new pixel between pixels in an image at the time of image size enlargement or reduction processing, the apparatus comprising:
i) boundary setting means for operating such that, in cases where it has been detected that an edge is located between the pixels, between which the new pixel is to be interpolated, the boundary setting means sets a predetermined boundary between the pixels, between which the new pixel is to be interpolated,
ii) judgment means for making a judgment as to whether a position of the new pixel to be interpolated is located on one side of the predetermined boundary or is located on the other side of the predetermined boundary, and
iii) interpolating operation means for operating such that:
   a) in cases where it has been judged that the position of the new pixel is located on the one side of the predetermined boundary,
   the interpolating operation means performs an interpolating operation by use of a pixel value of at least one pixel, which is located on the one side of the predetermined boundary in the image, in order to calculate a pixel value of the new pixel, and
   b) in cases where it has been judged that the position of the new pixel is located on the other side of the predetermined boundary,
   the interpolating operation means performs an interpolating operation by use of the pixel value of at least one pixel, which is located on the other side of the predetermined boundary in the image, in order to calculate a pixel value of the new pixel.

In the image interpolation apparatus in accordance with the present invention, in cases where it has been detected that an edge is not located between the pixels, between which the new pixel is to be interpolated, the interpolating operation may be performed with one of various known techniques, such as the linear interpolation technique, the nearest neighbor interpolation technique, the bilinear technique, and the bicubic technique.

The image interpolation apparatus in accordance with the present invention may be modified such that the predetermined boundary is a line bisecting the distance between the pixels, between which the new pixel is to be interpolated.

Alternatively, in cases where the edge detection is performed such that the location of the edge is capable of being found, the position of the edge may be set as the predetermined boundary.

The present invention also provides an image interpolation method for interpolating a new pixel between pixels in an image at the time of image size enlargement or reduction processing, the method comprising the steps of:
i) operating such that, in cases where it has been detected that an edge is located between the pixels, between which the new pixel is to be interpolated, a predetermined boundary is set between the pixels, between which the new pixel is to be interpolated,
ii) making a judgment as to whether a position of the new pixel to be interpolated is located on one side of the predetermined boundary or is located on the other side of the predetermined boundary, and
iii) performing an interpolating operation such that:
   a) in cases where it has been judged that the position of the new pixel is located on the one side of the predetermined boundary,
   the interpolating operation is performed by use of a pixel value of at least one pixel, which is located on the one side of the predetermined boundary in the image, in order to calculate a pixel value of the new pixel, and
   b) in cases where it has been judged that the position of the new pixel is located on the other side of the predetermined boundary,
   the interpolating operation is performed by use of the pixel value of at least one pixel, which is located on the other side of the predetermined boundary in the image, in order to calculate a pixel value of the new pixel.

The present invention further provides a computer program for causing a computer to execute the image interpolation method in accordance with the present invention.

The present invention still further provides a computer readable recording medium, on which the computer program has been recorded.

A skilled artisan would know that the computer readable recording medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of the present invention. Additionally, computer code/instructions include, but are not limited to, source, object, and executable code and can be in any language including higher level languages, assembly language, and machine language.

With the image interpolation apparatus and method in accordance with the present invention, in cases where it has been detected that an edge is located between the pixels, between which the new pixel is to be interpolated, the predetermined boundary is set between the pixels, between which the new pixel is to be interpolated, and the judgment is made as to whether the position of the new pixel to be interpolated is located on one side of the predetermined boundary or is located on the other side of the predetermined boundary. In cases where it has been judged that the position of the new pixel is located on the one side of the predetermined boundary, the interpolating operation is performed by use of the pixel value of at least one pixel, which is located on the one side of the predetermined boundary in the image, and the pixel value of the new pixel is thereby calculated. Also, in cases where it has been judged that the position of the new pixel is located on the other side of the predetermined boundary, the interpolating operation is performed by use of the pixel value of at least one pixel, which is located on the other side of the predetermined boundary in the image, and the pixel value of the new pixel is thereby calculated. Therefore, the pixel value of the new pixel is not affected by the pixel values of the pixels, which are located on opposite sides of the new pixel, and reflects only the pixel value of the at least one pixel, which is located on the single side of the new pixel. Accordingly, with the image interpolation apparatus andmethod in accordance with the present invention, the calculation of the pixel value of the new pixel is capable of being made such that less blurring of the edge may occur than in cases where, as illustrated in FIG. 27A or FIG. 27B, the pixel value of the new pixel is calculated by use of the pixel values of the pixels, which are located on opposite sides of the new pixel. In this manner, the image, which has a size having been enlarged or reduced, is capable of being obtained such that the image may be free from the blurring of the edge.

The present invention also provides a first edge detecting apparatus, comprising:
i) filtering means for performing filtering processing with a difference filter and on each of pixel pairs, each of the pixel pairs being constituted of two pixels, which are adjacent to each other and are contained in an even number of pixels that are at least four pixels and are adjacent in series to one another in an image, and thereby obtaining a difference between pixel values of the two pixels, which are adjacent to each other and constitute each of the pixel pairs, a plurality of differences being obtained for the pixel pairs, and
ii) judgment means for operating such that:
   a) the judgment means makes a judgment as to whether an absolute value of the difference between the pixel values of the pixel pair constituted of two middle pixels, which are among the even number of the pixels that are adjacent in series to one another in the image, is or is not a maximum value among the absolute values of the differences having been obtained for all of the pixel pairs, and
   b) in cases where it has been judged that the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs,
   the judgment means judges that an edge is located between the two middle pixels, which are among the even number of the pixels that are adjacent in series to one another in the image.

The term “difference filter” as used herein embraces the filter for calculating a simple difference between the two pixels, which are adjacent to each other, and the filter capable of calculating a weighted difference. Specifically, a filter having an even number of taps, e.g. a filter having two taps with filter values of (−1, 1), may be employed as the difference filter.

The present invention further provides a second edge detecting apparatus, comprising:
i) filtering means for performing filtering processing with a difference filter and on each of pixel pairs, each of the pixel pairs being constituted of two pixels, which are adjacent to each other and are contained in an even number of pixels that are at least four pixels and are adjacent in series to one another in an image, and thereby obtaining a difference between pixel values of the two pixels, which are adjacent to each other and constitute each of the pixel pairs, a plurality of differences being obtained for the pixel pairs, and
ii) judgment means for operating such that:
   a) the judgment means makes a judgment as to whether an absolute value of the difference between the pixel values of the pixel pair constituted of two middle pixels, which are among the even number of the pixels that are adjacent in series to one another in the image, is or is not equal to at least a predetermined threshold value, and
   b) in cases where it has been judged that the absolute value of the difference between the pixel values of the pixel pair constituted of the two middle pixels, which are among the even number of the pixels that are adjacent in series to one another in the image, is equal to at least the predetermined threshold value,
   the judgment means judges that an edge is located between the two middle pixels, which are among the even number of the pixels that are adjacent in series to one another in the image.

The second edge detecting apparatus in accordance with the present invention may be modified such that the judgment means operates such that:
a) in cases where it has been judged that the absolute value of the difference between the pixel values of the pixel pair constituted of the two middle pixels, which are among the even number of the pixels that are adjacent in series to one another in the image, is not equal to at least the predetermined threshold value,
the judgment means makes a judgment as to whether or not the absolute value of the difference between the pixel values of the pixel pair constituted of the two middle pixels, which are among the even number of the pixels that are adjacent in series to one another in the image, is equal to at least a threshold value, which is smaller than the predetermined threshold value, and at the same time the absolute value of the difference between the pixel values of the pixel pair constituted of the two middle pixels, which are among the even number of the pixels that are adjacent in series to one another in the image, is a maximum value among the absolute values of the differences having been obtained for all of the pixel pairs, and
b) in cases where it has been judged that the absolute value of the difference between the pixel values of the pixel pair constituted of the two middle pixels, which are among the even number of the pixels that are adjacent in series to one another in the image, is equal to at least the threshold value, which is smaller than the predetermined threshold value, and at the same time the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs,
the judgment means judges that an edge is located between the two middle pixels, which are among the even number of the pixels that are adjacent in series to one another in the image.

Also, each of the first and second edge detecting apparatuses in accordance with the present invention may be modified such that, in cases where a judgment is to be made as to whether an edge is or is not located between two pixels, which are adjacent to each other and constitute each of six pixel pairs of interest in an array of four adjacent pixels in an image, the four adjacent pixels being arrayed in a form of 2×2 pixels,
the judgment means takes an even number of pixels that are at least four pixels, which contain the two pixels constituting each of the six pixel pairs of interest in the array of the four adjacent pixels in the image, and which contain pixels adjacent in series to the pixel pair of interest on opposite sides of the pixel pair of interest and symmetrically with respect to the pixel pair of interest, as the even number of the pixels that are at least four pixels and are adjacent in series to one another in the image,
the judgment means takes the two pixels, which constitute each of the six pixel pairs of interest, as the two middle pixels, which are among the even number of the pixels that are adjacent in series to one another in the image, and
the judgment means makes a judgment as to whether an edge is or is not located between the two pixels, which constitute each of the six pixel pairs of interest.

In such cases, each of the first and second edge detecting apparatuses in accordance with the present invention may be modified such that the apparatus further comprises edge pattern classifying means for operating such that:
in cases where an edge has been detected between the two pixels, which constitute one of the six pixel pairs of interest,
the edge pattern classifying means classifies an edge pattern within an area of the array of the four adjacent pixels in the image, the four adjacent pixels being arrayed in the form of 2×2 pixels, in accordance with a position at which the edge has been detected.

The present invention still further provides a first edge detecting method, comprising the steps of:
i) performing filtering processing with a difference filter and on each of pixel pairs, each of the pixel pairs being constituted of two pixels, which are adjacent to each other and are contained in an even number of pixels that are at least four pixels and are adjacent in series to one another in an image, a difference between pixel values of the two pixels, which are adjacent to each other and constitute each of the pixel pairs, being obtained from the filtering processing, a plurality of differences being obtained for the pixel pairs, and
ii) performing judgment processing such that:
   a) a judgment is made as to whether an absolute value of the difference between the pixel values of the pixel pair constituted of two middle pixels, which are among the even number of the pixels that are adjacent in series to one another in the image, is or is not a maximum value among the absolute values of the differences having been obtained for all of the pixel pairs, and
   b) in cases where it has been judged that the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs,
   it is judged that an edge is located between the two middle pixels, which are among the even number of the pixels that are adjacent in series to one another in the image.

The present invention also provides a second edge detecting method, comprising the steps of:
i) performing filtering processing with a difference filter and on each of pixel pairs, each of the pixel pairs being constituted of two pixels, which are adjacent to each other and are contained in an even number of pixels that are at least four pixels and are adjacent in series to one another in an image, a difference between pixel values of the two pixels, which are adjacent to each other and constitute each of the pixel pairs, being obtained from the filtering processing, a plurality of differences being obtained for the pixel pairs, and
ii) performing judgment processing such that:
   a) a judgment is made as to whether an absolute value of the difference between the pixel values of the pixel pair constituted of two middle pixels, which are among the even number of the pixels that are adjacent in series to one another in the image, is or is not equal to at least a predetermined threshold value, and
   b) in cases where it has been judged that the absolute value of the difference between the pixel values of the pixel pair constituted of the two middle pixels, which are among the even number of the pixels that are adjacent in series to one another in the image, is equal to at least the predetermined threshold value,
   it is judged that an edge is located between the two middle pixels, which are among the even number of the pixels that are adjacent in series to one another in the image.

The present invention further provides a computer program for causing a computer to execute the first edge detecting method or the second edge detecting method in accordance with the present invention.

The present invention still further provides a computer readable recording medium, on which the computer program has been recorded.

With the first edge detecting apparatus and method in accordance with the present invention, the filtering processing is performed with the difference filter and on each of the pixel pairs, each of the pixel pairs being constituted of the two pixels, which are adjacent to each other and are contained in the even number of the pixels that are at least four pixels and are adjacent in series to one another in the image. The difference between the pixel values of the two pixels, which are adjacent to each other and constitute each of the pixel pairs, is obtained from the filtering processing, and the plurality of the differences are obtained for the pixel pairs. Also, the judgment is made as to whether the absolute value of the difference between the pixel values of the pixel pair constituted of the two middle pixels, which are among the even number of the pixels that are adjacent in series to one another in the image, is or is not the maximum value among the absolute values of the differences having been obtained for all of the pixel pairs. In cases where it has been judged that the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs, it may be regarded that an edge is located between the two middle pixels, which are among the even number of the pixels that are adjacent in series to one another in the image. Therefore, with the first edge detecting apparatus and method in accordance with the present invention, instead of a detection being made as to whether an edge is or is not located at a pixel in the image, the detection is capable of being made as to whether an edge is or is not located between pixels in the image. Also, since it is sufficient for the differences described above to be calculated, the detection as to whether an edge is or is not located between the pixels in the image is capable of being made quickly with simple operation processing.

With the second edge detecting apparatus and method in accordance with the present invention, the filtering processing is performed with the difference filter and on each of the pixel pairs, each of the pixel pairs being constituted of the two pixels, which are adjacent to each other and are contained in the even number of the pixels that are at least four pixels and are adjacent in series to one another in the image. The difference between the pixel values of the two pixels, which are adjacent to each other and constitute each of the pixel pairs, is obtained from the filtering processing, and the plurality of the differences are obtained for the pixel pairs. Also, the judgment is made as to whether the absolute value of the difference between the pixel values of the pixel pair constituted of the two middle pixels, which are among the even number of the pixels that are adjacent in series to one another in the image, is or is not equal to at least the predetermined threshold value. In cases where it has been judged that the absolute value of the difference between the pixel values of the pixel pair constituted of the two middle pixels, which are among the even number of the pixels that are adjacent in series to one another in the image, is equal to at least the predetermined threshold value, it may be regarded that an edge is located between the two middle pixels, which are among the even number of the pixels that are adjacent in series to one another in the image. Therefore, with the second edge detecting apparatus and method in accordance with the present invention, wherein the judgment is made as to whether the absolute value of the difference between the pixel values of the pixel pair constituted of the two middle pixels, which are among the even number of the pixels that are adjacent in series to one another in the image, is or is not equal to at least the predetermined threshold value, instead of a detection being made as to whether an edge is or is not located at a pixel in the image, the detection is capable of being made as to whether an edge is or is not located betweenpixels in the image. Also, since it is sufficient for the differences described above to be calculated, the detection as to whether an edge is or is not located between the pixels in the image is capable of being made quickly with simple operation processing.

Each of the second edge detecting apparatus and method in accordance with the present invention may be modified such that judgment processing is performed such that:
a) in cases where it has been judged that the absolute value of the difference between the pixel values of the pixel pair constituted of the two middle pixels, which are among the even number of the pixels that are adjacent in series to one another in the image, is not equal to at least the predetermined threshold value,
the judgment is made as to whether or not the absolute value of the difference between the pixel values of the pixel pair constituted of the two middle pixels, which are among the even number of the pixels that are adjacent in series to one another in the image, is equal to at least the threshold value, which is smaller than the predetermined threshold value, and at the same time the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs, and
b) in cases where it has been judged that the absolute value of the difference between the pixel values of the pixel pair constituted of the two middle pixels, which are among the even number of the pixels that are adjacent in series to one another in the image, is equal to at least the threshold value, which is smaller than the predetermined threshold value, and at the same time the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs,
it is judged that an edge is located between the two middle pixels, which are among the even number of the pixels that are adjacent in series to one another in the image.

With the aforesaid modification of each of the second edge detecting apparatus and method in accordance with the present invention, the problems are capable of being prevented from occurring in that, in cases where an edge is located between the pixels, it is judged that an edge is not located between the pixels. The judgment is thus capable of being made more accurately as to whether an edge is or is not located between the pixels.

Also, each of the first edge detecting apparatus and method and the second edge detecting apparatus and method in accordance with the present invention may be modified such that, in cases where the judgment is to be made as to whether an edge is or is not located between the two pixels, which are adjacent to each other and constitute each of the six pixel pairs of interest in the array of the four adjacent pixels in the image, the four adjacent pixels being arrayed in the form of 2×2 pixels,
the even number of the pixels that are at least four pixels, which contain the two pixels constituting each of the six pixel pairs of interest in the array of the four adjacent pixels in the image, and which contain the pixels adjacent in series to the pixel pair of interest on opposite sides of the pixel pair of interest and symmetrically with respect to the pixel pair of interest, are taken as the “even number of the pixels that are at least four pixels and are adjacent in series to one another in the image,” as defined in each of the first edge detecting apparatus and method and the second edge detecting apparatus and method in accordance with the present invention,
the two pixels, which constitute each of the six pixel pairs of interest, are taken as the “two middle pixels, which are among the even number of the pixels that are adjacent in series to one another in the image,” and
the judgment is made as to whether an edge is or is not located between the two pixels, which constitute each of the six pixel pairs of interest.

With the aforesaid modification of each of the first edge detecting apparatus and method and the second edge detecting apparatus and method in accordance with the present invention, an edge located between the two pixels, which are adjacent to each other and constitute each of the six pixel pairs of interest in the array of the four adjacent pixels in the image, the four adjacent pixels being arrayed in the form of 2×2 pixels, is capable of being detected accurately.

Further, each of the first edge detecting apparatus and method and the second edge detecting apparatus and method in accordance with the present invention may be modified such that, in cases where an edge has been detected between the two pixels, which constitute one of the six pixel pairs of interest, the edge pattern within the area of the array of the four adjacent pixels in the image, the four adjacent pixels being arrayed in the form of 2×2 pixels, is classified in accordance with the position at which the edge has been detected. In such cases, the edge pattern is capable of being classified accurately.

### BRIEF DESCRIPTION OF THE DRAWINGS

FIG. 1 is a block diagram showing an image size enlarging and reducing apparatus, in which an embodiment of the image interpolation apparatus in accordance with the present invention is employed,

FIG. 2 is an explanatory view showing an array of pixels in an image, which is represented by an image signal,

FIG. 3 is an explanatory view showing how filtering processing is performed in a filtering section in the image size enlarging and reducing apparatus of FIG. 1, in which the embodiment of the image interpolation apparatus in accordance with the present invention is employed,

FIG. 4 is an explanatory view showing an example of a difference filter,

FIG. 5 is a table showing examples of relationships of positive and negative signs among primary differences d1, d2, d3 and secondary differences d4, d5, and corresponding shapes of profiles of pixel values of four pixels that are adjacent in series to one another,

FIG. 6 is a table showing different examples of relationships of positive and negative signs among primary differences d1, d2, d3 and secondary differences d4, d5, and corresponding shapes of profiles of pixel values of four pixels that are adjacent in series to one another,

FIG. 7 is a table showing further different examples of relationships of positive and negative signs among primary differences d1, d2, d3 and secondary differences d4, d5, and corresponding shapes of profiles of pixel values of four pixels that are adjacent in series to one another,

FIG. 8 is an explanatory view showing an example of a shape of a profile, in which a difference between pixel values of two pixels that are adjacent to each other is markedly small, and for which it is judged that an edge is located between the two pixels that are adjacent to each other,

FIG. 9 is an explanatory view showing how a bicubic technique is performed,

FIG. 10A is an explanatory view showing an example of how a pixel value of a pixel to be interpolated in an area, which has been judged as containing an edge, is calculated,

FIG. 10B is an explanatory view showing a different example of how a pixel value of a pixel to be interpolated in an area, which has been judged as containing an edge, is calculated,

FIG. 11 is a flow chart showing how processing is performed in the image size enlarging and reducing apparatus of FIG. 1, in which the embodiment of the image interpolation apparatus in accordance with the present invention is employed,

FIG. 12 is a flow chart showing how a first interpolating operation is performed,

FIG. 13 is a block diagram showing an image size enlarging and reducing apparatus, in which an embodiment of the edge detecting apparatus in accordance with the present invention is employed,

FIG. 14 is an explanatory view showing pixel lines, each of which passes through two pixels among four middle pixels in an array of 16 pixels that are located in the vicinity of a pixel to be interpolated,

FIG. 15 is an explanatory view showing how filtering processing is performed in a filtering section in the image size enlarging and reducing apparatus of FIG. 13, in which the embodiment of the edge detecting apparatus in accordance with the present invention is employed,

FIG. 16 is an explanatory view showing a location of an edge between pixels,

FIG. 17 is a table showing examples of edge patterns in accordance with locations of edges,

FIG. 18 is a table showing different examples of edge patterns in accordance with locations of edges,

FIG. 19 is a table showing further different examples of edge patterns in accordance with locations of edges,

FIG. 20 is an explanatory view showing an example of an edge pattern in an array of 16 pixels,

FIG. 21 is an explanatory view showing an example of how a pixel value of a pixel to be interpolated is calculated with a one-dimensional interpolating operation,

FIG. 22 is an explanatory view showing an example of how a pixel value of a pixel to be interpolated is calculated with a two-dimensional interpolating operation,

FIG. 23 is a flow chart showing how processing is performed in the image size enlarging and reducing apparatus of FIG. 13, in which the embodiment of the edge detecting apparatus in accordance with the present invention is employed,

FIG. 24 is a view showing a sample image,

FIG. 25 is a view showing a result of detection of edges with a Laplacian filter,

FIG. 26 is a view showing a result of detection of edges with the technique in accordance with the present invention, and

FIGS. 27A and 27B are explanatory views showing how a conventional interpolating operation is performed.

### DESCRIPTION OF THE PREFERRED EMBODIMENTS

The present invention will hereinbelow be described in further detail with reference to the accompanying drawings.

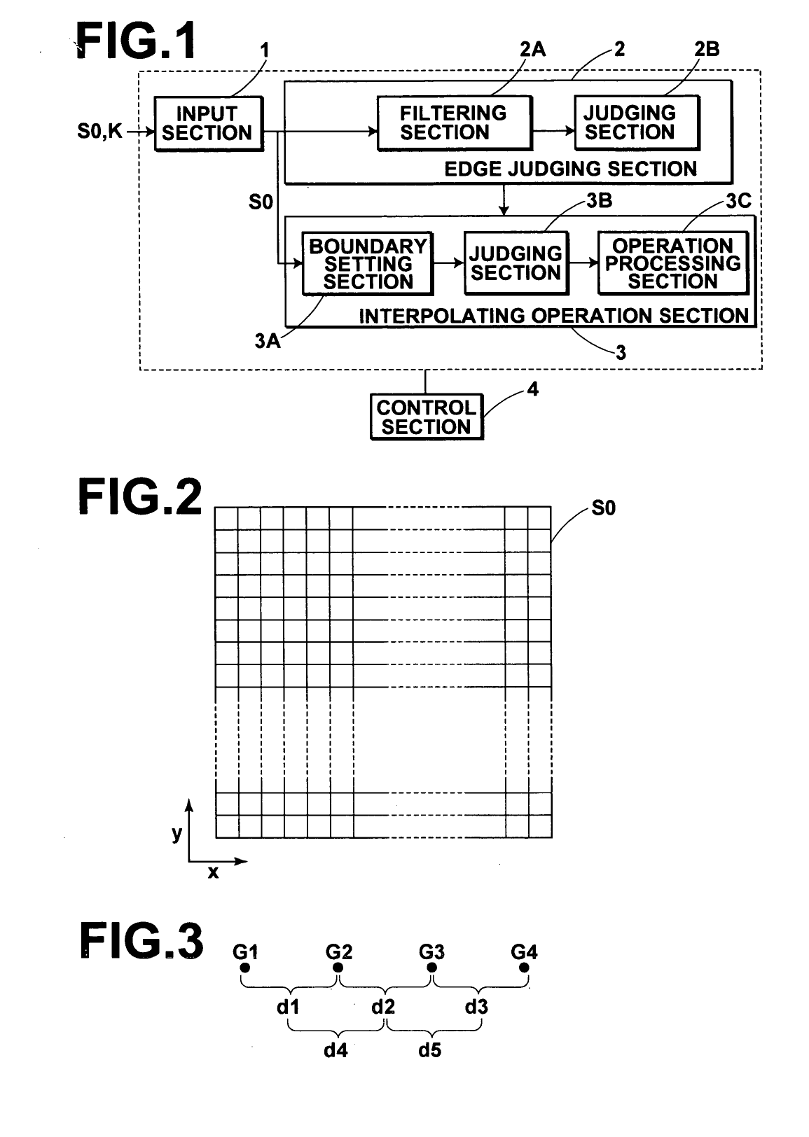

FIG. 1 is a block diagram showing an image size enlarging and reducing apparatus, in which an embodiment of the image interpolation apparatus in accordance with the present invention is employed. As illustrated in FIG. 1, the image size enlarging and reducing apparatus, in which the embodiment of the image interpolation apparatus in accordance with the present invention is employed, comprises an input section 1 for accepting inputs of an image signal S0 and information representing an enlargement scale factor K for the image signal S0. The image size enlarging and reducing apparatus also comprises an edge judging section 2, and an interpolating operation section 3 for calculating a pixel value of a pixel to be interpolated for image size enlargement or reduction processing. (The pixel to be interpolated for the image size enlargement or reduction processing, will hereinbelow be referred to as the interpolated pixel P.) The image size enlarging and reducing apparatus further comprises a control section 4 for controlling the operations of the input section 1, the edge judging section 2, and the interpolating operation section 3.

As illustrated in FIG. 2, the image represented by the image signal S0 is constituted of pixels arrayed in two-dimensional directions. (The image represented by the image signal S0 will hereinbelow be also represented by S0.) In the image size enlarging and reducing apparatus of FIG. 1, in which the embodiment of the image interpolation apparatus in accordance with the present invention is employed, an x direction and a y direction are defined as illustrated in FIG. 2.

The edge judging section 2 is provided with a filtering section 2A and a judging section 2B.

The filtering section 2A performs filtering processing in the manner described below. FIG. 3 is an explanatory view showing how the filtering processing is performed in the filtering section 2A in the image size enlarging and reducing apparatus of FIG. 1, in which the embodiment of the image interpolation apparatus in accordance with the present invention is employed. Specifically, with respect to each of rows of the pixels in the image S0, which rows extend in the x direction, and each of columns of the pixels in the image S0, which columns extend in the y direction, the filtering section 2A performs the filtering processing with a difference filter. More specifically, as illustrated in FIG. 3, the four pixels G1, G2, G3, and G4, which are adjacent in series to one another, are composed of the two pixels G2 and G3, which are adjacent to each other and between which the interpolated pixel P is located, the pixel G1 adjacent to the pixel G2, and the pixel G4 adjacent to the pixel G3. With respect to the four pixels G1, G2, G3, and G4, which are adjacent in series to one another, the filtering section 2A performs the filtering processing with the difference filter and on each of three pixel pairs, each of the three pixel pairs being constituted of the two pixels, which are adjacent to each other, i.e. on each of a pixel pair of G1 and G2, a pixel pair of G2 and G3, and a pixel pair of G3 and G4. The filtering section 2A thereby obtains the difference between the pixel values of the pixel pair of G1 and G2 as a primary difference d1. The filtering section 2A also obtains the difference between the pixel values of the pixel pair of G2 and G3 as a primary difference d2. The filtering section 2A further obtains the difference between the pixel values of the pixel pair of G3 and G4 as a primary difference d3.

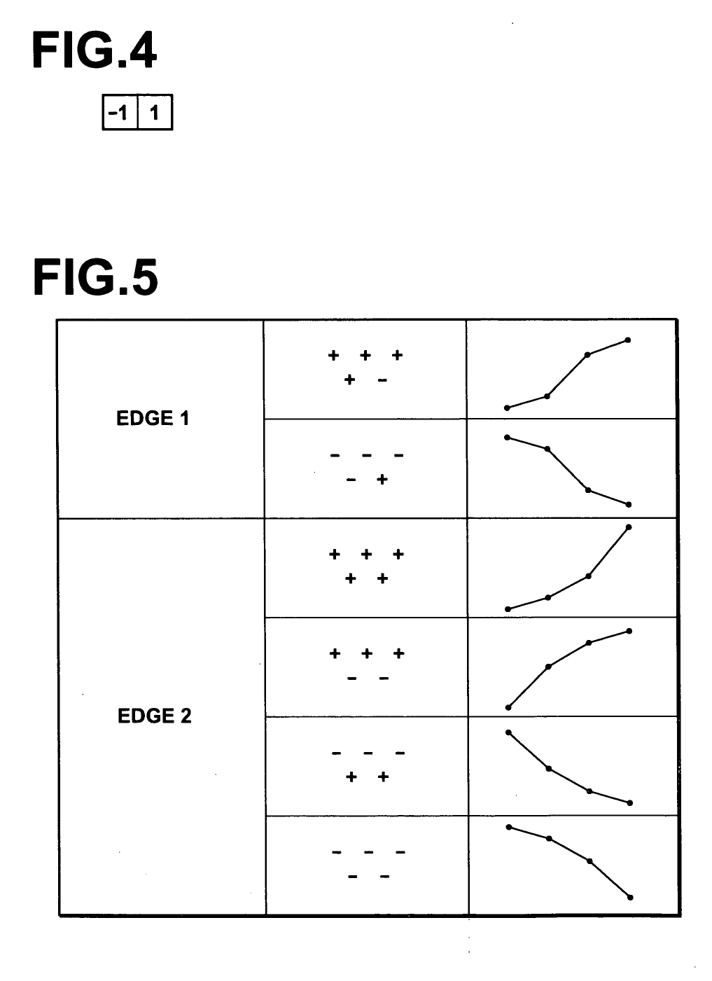

FIG. 4 is an explanatory view showing an example of a difference filter. As illustrated in FIG. 4, in the image size enlarging and reducing apparatus of FIG. 1, in which the embodiment of the image interpolation apparatus in accordance with the present invention is employed, the difference filter employed in the filtering section 2A is a filter having two taps with filter values of (−1, 1). However, the difference filter is not limited to the filter having the two taps with the filter values of (−1, 1). For example, a filter having filter values capable of calculating a weighted difference between the pixel values of the two pixels may be employed as the difference filter. Alternatively, a filter having an even number of taps more than two taps may be employed as the difference filter.

Thereafter, the filtering section 2A performs the filtering processing with the difference filter and on each of two primary difference pairs, each of the two primary difference pairs being constituted of the two primary differences, which are adjacent to each other and are contained in the thus obtained three primary differences d1, d2, and d3, i.e. on each of the primary difference pair of d1 and d2 and the primary difference pair of d2 and d3. The filtering section 2A thereby obtains the difference between the primary difference pair of d1 and d2 as a secondary difference d4. The filtering section 2A also obtains the difference between the primary difference pair of d2 and d3 as a secondary difference d5.

Also, the filtering section 2A performs the filtering processing on the two middle pixels G2 and G3, which are among the four pixels G1, G2, G3, and G4 that are adjacent in series to one another in the image S0. The filtering section 2A thus calculates a difference d0 (=d2) between the pixel values of the pixels G2 and G3. Alternatively, the primary difference d2 described above may be directly utilized as the difference d0.

The judging section 2B makes a judgment (i.e., a first judgment) as to whether an edge is or is not located between the two pixels G2 and G3, which are adjacent to each other. The first judgment is made in accordance with a relationship of positive and negative signs among the primary differences d1, d2, d3 and the secondary differences d4, d5.

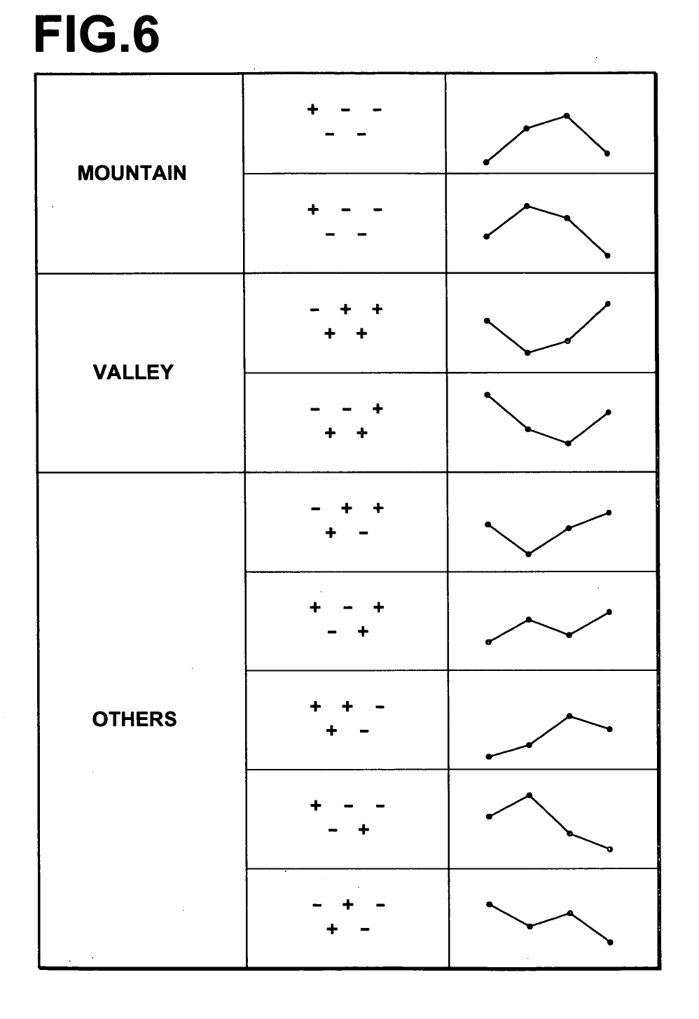

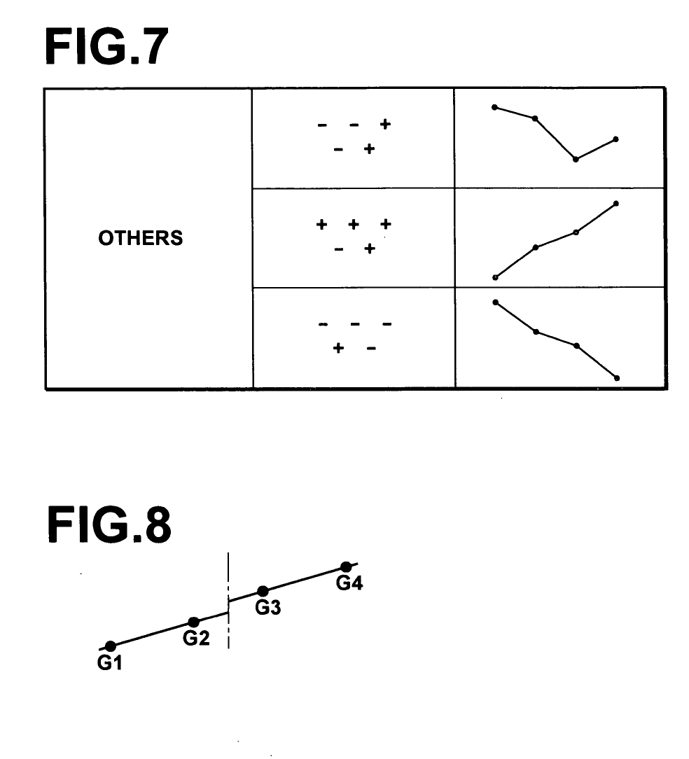

FIG. 5, FIG. 6, and FIG. 7 are tables showing examples of relationships of positive and negative signs among the primary differences d1, d2, d3 and the secondary differences d4, d5, which have been obtained with respect to the four pixels that are adjacent in series to one another, and corresponding shapes of profiles of the pixel values of the four pixels that are adjacent in series to one another. As the combinations of the positive and negative signs of the primary differences d1, d2, d3 and the secondary differences d4, d5, which have been obtained with respect to the four pixels that are adjacent in series to one another, there are 18 kinds of combinations in total. As illustrated in FIG. 5, as the combinations of the positive and negative signs of the primary differences d1, d2, d3 and the secondary differences d4, d5, which combinations are obtained in cases where an edge is located between the two pixels G2 and G3 adjacent to each other, there are two kinds of combinations, i.e. the combination “edge 1” and the combination “edge 2.” The combination “edge 1” is classified into two kinds of profiles, i.e. a rightward ascending edge profile in which (d1, d2, d3, d4, d5 )=(+, +, +, +, −), and a leftward ascending edge profile in which (d1, d2, d3, d4, d5 )=(−, −, −, −, +). The combination “edge 2” is classified into four kinds of profiles, i.e. a downward convex, rightward ascending edge profile in which (d1, d2, d3, d4, d5 )=(+, +, +, +, +), an upward convex, rightward ascending edge profile in which (d1, d2, d3, d4, d5 )=(+, +, +, −, −), a downward convex, leftward ascending edge profile in which (d1, d2, d3, d4, d5 )=(−, −, −, +, +), and an upward convex, leftward ascending edge profile in which (d1, d2, d3, d4, d5 )=(−, −, −, −, −).

The judging section 2B stores the information representing the tables illustrated in FIG. 5, FIG. 6, and FIG. 7. In cases where the relationship of positive and negative signs among the primary differences d1, d2, d3 and the secondary differences d4, d5, which have been obtained with respect to the four pixels that are adjacent in series to one another, coincides with the relationship of “edge 1” or the relationship of “edge 2” illustrated in FIG. 5, the judging section 2B judges that an edge is located between the two pixels G2 and G3 that are adjacent to each other. Also, in cases where the relationship of positive and negative signs among the primary differences d1, d2, d3 and the secondary differences d4, d5, which have been obtained with respect to the four pixels that are adjacent in series to one another, coincides with the relationship of “mountain,” the relationship of “valley,” or the relationship of “others” illustrated in FIG. 6 or FIG. 7, the judging section 2B judges that an edge is not located between the two pixels G2 and G3 that are adjacent to each other.

Further, in cases where it has been judged with the first judgment that an edge is located between the two pixels G2 and G3 that are adjacent to each other, the judging section 2B makes a judgment (i.e., a second judgment) as to whether the absolute value of the difference d0 is or is not equal to at least the threshold value Th1. In cases where it has been judged with the second judgment that the absolute value of the difference d0 is equal to at least the threshold value Th1, the judging section 2B judges that a true edge is located between the two pixels G2 and G3. In cases where it has been judged with the second judgment that the absolute value of the difference d0 is not equal to at least the threshold value Th1, the judging section 2B judges that an edge is not located between the two pixels G2 and G3. The second judgment is thus performed in order to prevent the problems from occurring in that, as illustrated in, for example, FIG. 8, in cases where the difference between the pixel values of the pixels G2 and G3 is markedly small and may be regarded as being noise, if it has been judged with the first judgment that an edge is located between the pixels G2 and G3, the interpolating operation section 3 will perform an interpolating operation, which is appropriate for an edge area, as will be described later in accordance with the result of the first judgment, and noise will thus be enhanced. After the judgments have been made in the manner described above, the edge judging section 2 feeds the information, which represents the results of the judgments, into the interpolating operation section 3.

The interpolating operation section 3 is provided with a boundary setting section 3A, a judging section 3B, and an operation processing section 3C. In accordance with the result of the judgment having been made by the edge judging section 2, the operation processing section 3C performs different interpolating operations for the cases where it has been judged that an edge is located between the two pixels, which are adjacent to each other and between which the interpolated pixel P is located, and the cases where it has been judged that an edge is not located between the two pixels, which are adjacent to each other and between which the interpolated pixel P is located. The operation processing section 3C thus calculates the pixel value of the interpolated pixel P. Specifically, in cases where it has been judged that an edge is not located between the two pixels, which are adjacent to each other and between which the interpolated pixel P is located, the operation processing section 3C performs a bicubic technique and thereby calculates the pixel value of the interpolated pixel P.

The bicubic technique is one of techniques for interpolating operations of the third order. With the bicubic technique, the pixel value of the interpolated pixel P is calculated by use of 16 pixels, which are located in the vicinity of the interpolated pixel P. The bicubic technique will hereinbelow be described in more detail.

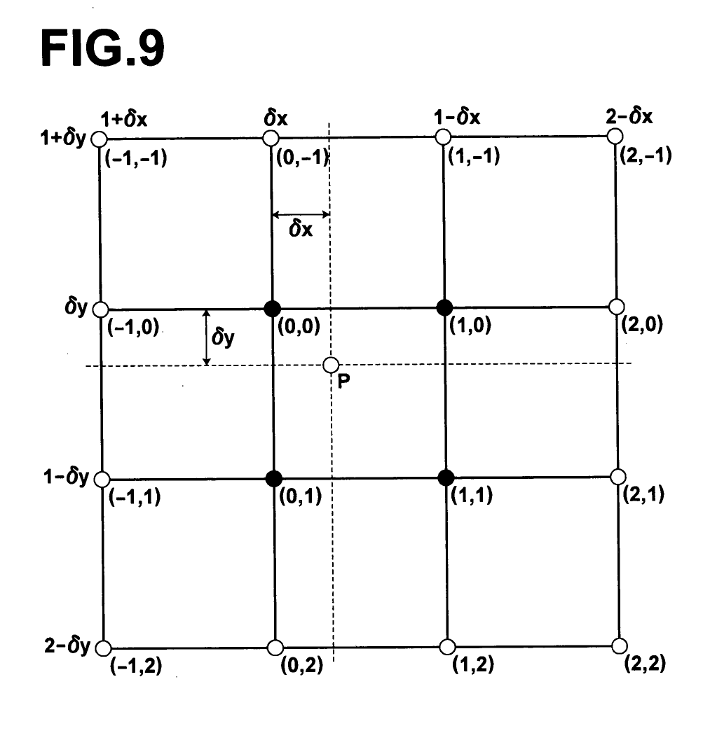

FIG. 9 is an explanatory view showing how a bicubic technique is performed. As illustrated in FIG. 9, in cases where a point P represents the position of the interpolated pixel P, the pixels represented by the black dots in FIG. 9 are referred to as the primary neighbors, and the pixels represented by the white dots in FIG. 9 are referred to as the secondary neighbors. As for each of the primary neighbors and each of the secondary neighbors, a weight factor Wx with respect to a distance dx in the x direction is calculated with Formula (1) shown below. Also, a weight factor Wy with respect to a distance dy in the y direction is calculated with Formula (1) shown below. (In Formula (1), each of dx and dy is represented simply by d.) Further, a weight factor W (W=WxWy) for the pixel is calculated.

$$W = \{ \begin{matrix}( d - 1 ) ( {d}^{2} - d - 1 ) & primaryneighbors \\ - ( d - 1 ) {( d - 2 )}^{2} & secondaryneighbors\end{matrix} \qquad ( 1 )$$

For example, as for the pixel (−1, −1) (which is one of the secondary neighbors) in FIG. 9, the weight factor Wx, the weight factor Wy, and the weight factor W are calculated with Formulas (2), (3), and (4) shown below.
Wx=δx(δx−1)² (2)
Wy=δy(δy−1)² (3)
W=δx(δx−1)² δy(δy−1)² (4)

Also, in cases where the weight factor for a pixel (i, j) is represented by W(i, j), and the pixel value of the pixel (i, j) is represented by f(i, j), a pixel value f′(P) of the interpolated pixel P is capable of being calculated with Formula (5) shown below.

$${f}^{′} ( p ) = {\sum }_{i = - 1}^{2} {\sum }_{j = - 1}^{2} W ( i , j ) f ( i , j ) \qquad ( 5 )$$

In the image size enlarging and reducing apparatus of FIG. 1, in which the embodiment of the image interpolation apparatus in accordance with the present invention is employed, the bicubic technique is applied to a one-dimensional direction alone, i.e. the x direction or the y direction alone, and the pixel value of the interpolated pixel P is thereby calculated.

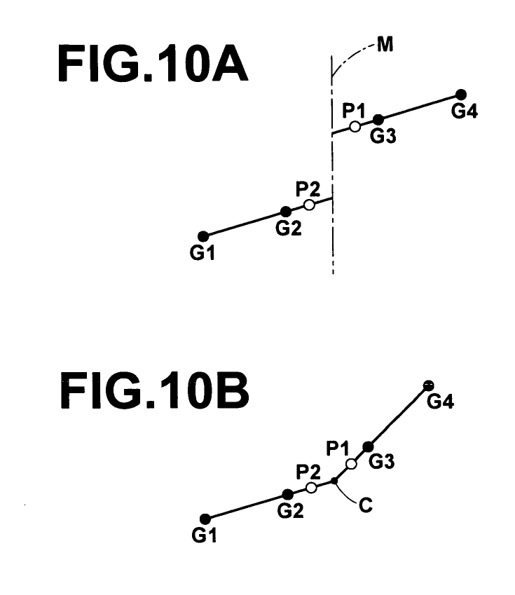

In cases where it has been judged that an edge is located between the two pixels, which are adjacent to each other and between which the interpolated pixel P is located, the pixel value of the interpolated pixel P is calculated in the manner described below. FIG. 10A is an explanatory view showing an example of a profile of pixel values of pixels located in an area, which has been judged as containing an edge. FIG. 10B is an explanatory view showing a different example of a profile of pixel values of pixels located in an area, which has been judged as containing an edge. In each of FIG. 10A and FIG. 10B, the horizontal direction represents the direction in which the pixels are arrayed, and the vertical direction represents the direction representing the levels of the pixel values of the pixels. In cases where it has been judged that an edge is located between two pixels G2 and G3, which are adjacent to each other, the profile of the pixel values of four pixels G1, G2, G3, and G4, which are composed of the two pixels G2, G3, the pixel G1 adjacent to the pixel G2, and the pixel G4 adjacent to the pixel G3, and which are adjacent in series to one another, takes the shape illustrated in FIG. 10A or FIG. 10B.

In cases where the profile takes the step-like edge shape as illustrated in FIG. 10A, the boundary setting section 3A sets a median line M, which is indicated by the single-dot chained line and which bisects the distance between the pixels G2 and G3 in the pixel array direction, as a boundary. Also, the judging section 3B makes a judgment as to whether the interpolated pixel P is located on the right side of the median line M or on the left side of the median line M. In cases where it has been judged by the judging section 3B that the interpolated pixel P is located on the right side of the median line M (in this case, the interpolated pixel P is represented by P1), the operation processing section 3C calculates a value lying on the extension of the straight line, which connects the pixels G3 and G4, as the pixel value of the interpolated pixel P1. Also, in cases where it has been judged by the judging section 3B that the interpolated pixel P is located on the left side of the median line M (in this case, the interpolated pixel P is represented by P2), the operation processing section 3C calculates a value lying on the extension of the straight line, which connects the pixels G1 and G2, as the pixel value of the interpolated pixel P2. In this embodiment, as described above, the median line M, which bisects the distance between the pixels G2 and G3 in the pixel array direction, is set as the boundary. Alternatively, in cases where the edge detection has been made such that the location of the edge is capable of being found, the position of the edge may be set as the boundary.

In cases where the profile takes the edge shape as illustrated in FIG. 10B, the boundary setting section 3A sets an intersection point C of the extension of the straight line, which connects the pixels G1 and G2, and the extension of the straight line, which connects the pixels G3 and G4, as the boundary. Also, the judging section 3B makes a judgment as to whether the interpolated pixel P1 is located on the right side of the intersection point C or on the left side of the intersection point C. In cases where it has been judged by the judging section 3B that the interpolated pixel P1 is located on the right side of the intersection point C, the operation processing section 3C calculates a value lying on the extension of the straight line, which connects the pixels G3 and G4, as the pixel value of the interpolated pixel P1. Also, in cases where it has been judged by the judging section 3B that the interpolated pixel P2 is located on the left side of the intersection point C, the operation processing section 3C calculates a value lying on the extension of the straight line, which connects the pixels G1 and G2, as the pixel value of the interpolated pixel P2.

In the image size enlarging and reducing apparatus of FIG. 1, the pixel value of the interpolated pixel P is calculated by use of the pixel values of only the two pixels (i.e., the pixels G3 and G4, or the pixels G1 and G2). Alternatively, the pixel value of the interpolated pixel P may be calculated by use of the pixel values of at least three pixels. In such cases, it may often occur that the at least three pixels cannot be connected by a straight line. Therefore, in such cases, the at least three pixels may be connected by a curved line defined by an arbitrary function, such as a spline curved line, and a value lying on the extension of the curved line may be taken as the pixel value of the interpolated pixel P.

The operation processing performed in cases where it has been judged that an edge is located between the two pixels, which are adjacent to each other and between which the interpolated pixel P is located, will hereinbelow be referred to as the first interpolating operation. Also, the operation processing performed in cases where it has been judged that an edge is not located between the two pixels, which are adjacent to each other and between which the interpolated pixel P is located, will hereinbelow be referred to as the second interpolating operation.

How the processing is performed in the image size enlarging and reducing apparatus of FIG. 1, in which the embodiment of the image interpolation apparatus in accordance with the present invention is employed, will be described hereinbelow.

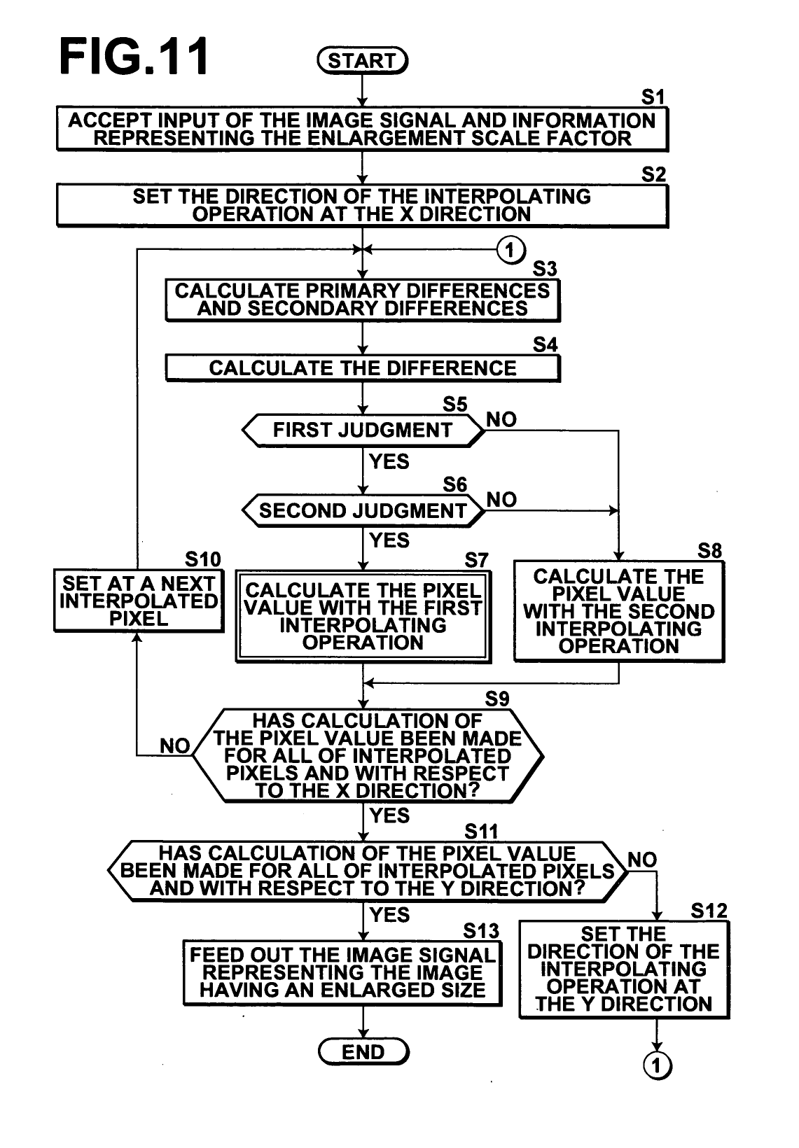

FIG. 11 is a flow chart showing how processing is performed in the image size enlarging and reducing apparatus of FIG. 1, in which the embodiment of the image interpolation apparatus in accordance with the present invention is employed. In the image size enlarging and reducing apparatus of FIG. 1, it is assumed that the interpolated pixel P is located between the pixels in the image S0. Firstly, in a step S1, the input section 1 accepts the image signal S0, which is to be subjected to the image size enlargement processing, and the information representing the enlargement scale factor K for the image signal S0. Also, in a step S2, the direction of the interpolating operation is set at the x direction. Thereafter, in a step S3, with respect to a first interpolated pixel P in accordance with the enlargement scale factor K (for example, a pixel located in an upper left area of an image represented by an image signal S1 obtained from the image size enlargement processing), the filtering section 2A of the edge judging section 2 calculates the primary differences d1, d2, d3 and the secondary differences d4, d5 from the four pixels G1, G2, G3, and G4 that are adjacent in series to one another and contain the two pixels G2 and G3 between which the interpolated pixel P is located. (The image represented by the image signal S1 will hereinbelow be also represented by S1.) Further, in a step S4, the filtering section 2A performs the filtering processing with the difference filter and on the pixels G2 and G3 and thereby calculates the difference d0.

Also, in a step S5, the judging section 2B makes the judgment (i.e., the first judgment) as to whether an edge is or is not located between the two pixels G2 and G3, which are adjacent to each other and between which the interpolated pixel P is located. The first judgment is made in accordance with the relationship of positive and negative signs among the primary differences d1, d2, d3 and the secondary differences d4, d5. In cases where it has been judged with the first judgment in the step S5 that an edge is located between the two pixels G2 and G3, in a step S6, the judging section 2B makes the judgment (i.e., the second judgment) as to whether the absolute value of the difference d0 is or is not equal to at least the threshold value Th1.

In cases where it has been judged with the second judgment in the step S6 that the absolute value of the difference d0 is equal to at least the threshold value Th1, in a step S7, it is regarded that an edge is located between the two middle pixels G2 and G3, which are among the four pixels G1, G2, G3, and G4 that are adjacent in series to one another in the image S0, and the interpolating operation section 3 calculates the pixel value of the interpolated pixel P with the first interpolating operation described above. In cases where it has been judged in the step S5 that an edge is not located between the two pixels G2 and G3, and in cases where it has been judged in the step S6 that the absolute value of the difference d0 is not equal to at least the threshold value Th1, in a step S8, it is regarded that an edge is not located between the two middle pixels G2 and G3, and the interpolating operation section 3 calculates the pixel value of the interpolated pixel P with the second interpolating operation described above.

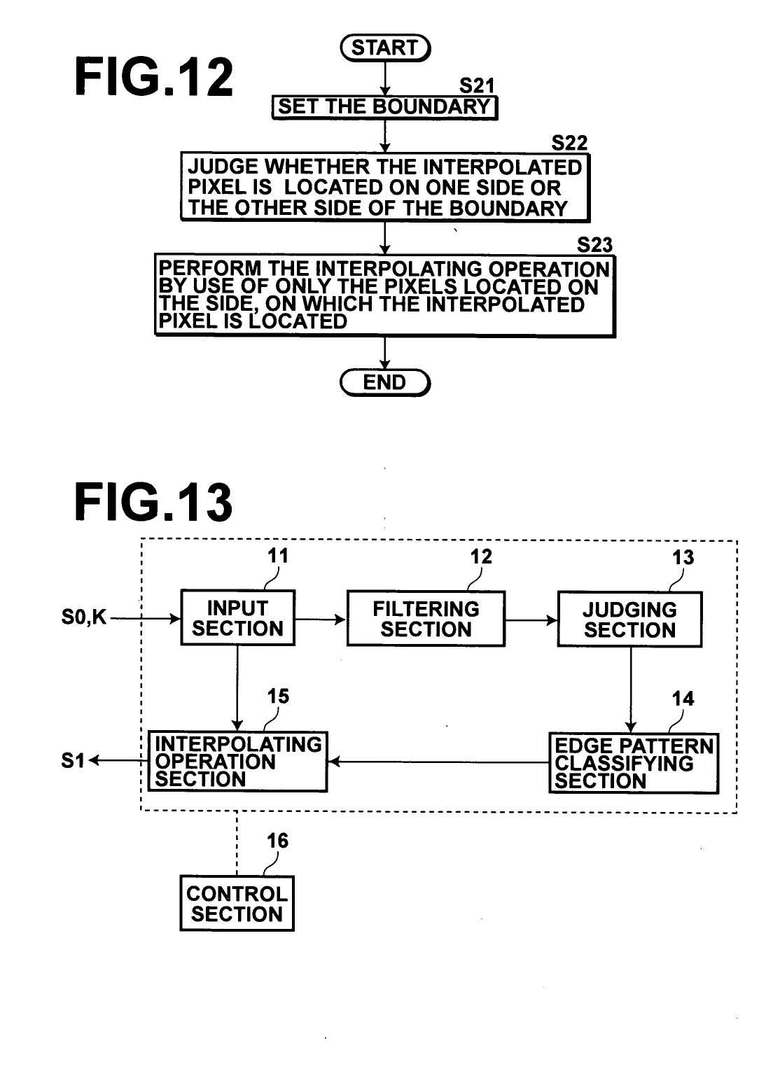

FIG. 12 is a flow chart showing how a first interpolating operation is performed. With reference to FIG. 12, firstly, in a step S21, the boundary setting section 3A of the interpolating operation section 3 sets the median line M or the intersection point C as the boundary between the two middle pixels G2 and G3. Also, in a step S22, the judging section 3B makes a judgment as to whether the interpolated pixel P is located on one side of the boundary or on the other side of the boundary. Further, in a step S23, the operation processing section 3C performs the interpolating operation by use of only the pixels located on the one side of the boundary or on the other side of the boundary, on which side the interpolated pixel P is located. The operation processing section 3C thus calculates the pixel value of the interpolated pixel P.

Reverting to FIG. 11, in a step S9, the control section 4 makes a judgment as to whether the calculation of the pixel value of the interpolated pixel P has been or has not been made with respect to all of interpolated pixels P, P, . . . and with respect to the x direction. In cases where it has been judged in the step S9 that the calculation of the pixel value of the interpolated pixel P has not been made with respect to all of interpolated pixels P, P, . . . and with respect to the x direction, in a step S10, the interpolated pixel P to be subjected to the calculation of the pixel value is set at a next interpolated pixel P. Also, the processing reverts to the step S3.

In cases where it has been judged in the step S9 that the calculation of the pixel value of the interpolated pixel P has been made with respect to all of interpolated pixels P, P, . . . and with respect to the x direction, in a step S11, a judgment is made as to whether the calculation of the pixel value of the interpolated pixel P has been or has not been made with respect to all of interpolated pixels P, P, . . . and with respect to the y direction. In cases where it has been judged in the step S11 that the calculation of the pixel value of the interpolated pixel P has not been made with respect to all of interpolated pixels P, P, . . . and with respect to the y direction, in a step S12, the direction of the interpolating operation is set at the y direction. Also, the processing reverts to the step S3. In cases where it has been judged in the step S11 that the calculation of the pixel value of the interpolated pixel P has been made with respect to all of interpolated pixels P, P, . . . and with respect to the y direction, in a step S13, the image signal S1, which represents the image S1 containing the interpolated pixels P, P, . . . and having an enlarged size, is fed out. At this stage, the processing is finished.

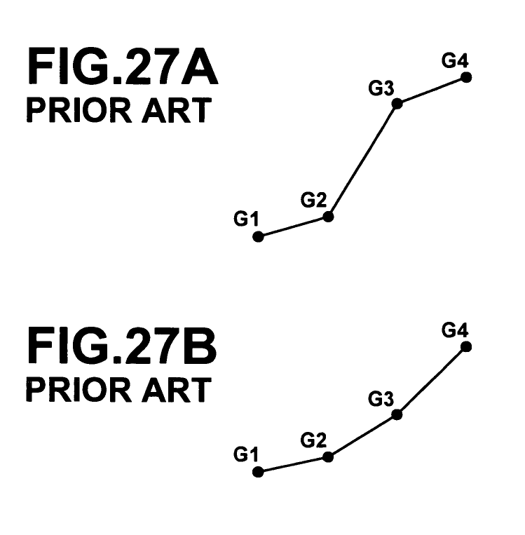

As described above, in the image size enlarging and reducing apparatus of FIG. 1, in which the embodiment of the image interpolation apparatus in accordance with the present invention is employed, in cases where it has been judged that an edge is located between the pixels in the image S0, as illustrated in FIG. 10A or FIG. 10B, a judgment is made as to whether the interpolated pixel P is located on the one side of the boundary or on the other side of the boundary. Further, the calculation of the pixel value of the interpolated pixel P is made by use of only the pixels located on the one side of the boundary or on the other side of the boundary, on which side the interpolated pixel P is located. Therefore, the pixel value of the interpolated pixel P is not affected by the pixel values of the pixels G2 and G3, which are located on opposite sides of the interpolated pixel P, and reflects only the pixel values of the pixels, which are located on the single side of the interpolated pixel P. Accordingly, with this embodiment of the image interpolation apparatus in accordance with the present invention, the calculation of the pixel value of the interpolated pixel P is capable of being made such that less blurring of the edge may occur than in cases where, as illustrated in FIG. 27A or FIG. 27B, the pixel value of the interpolated pixel P is calculated by use of the pixel values of the pixels G2 and G3, which are located on opposite sides of the interpolated pixel P. Accordingly, the image S1, which has a size having been enlarged or reduced, is capable of being obtained such that the image S1 may be free from the blurring of the edge.

In the image size enlarging and reducing apparatus of FIG. 1, in which the embodiment of the image interpolation apparatus in accordance with the present invention is employed, the filtering processing with the difference filter illustrated in FIG. 4 is performed on the pixels G1, G2, G3, and G4, and the primary differences d1, d2, d3 and the secondary differences d4, d5 are thereby calculated. Also, in accordance with the relationship of positive and negative signs among the primary differences d1, d2, d3 and the secondary differences d4, d5, and in accordance with the result of the judgment having been made as to whether the absolute value of the difference d0 is or is not equal to at least the threshold value Th1, a judgment is made as to whether an edge is or is not located between the pixels G2 and G3. Alternatively, the judgment as to whether an edge is or is not located between the pixels G2 and G3 may be made in accordance with only the relationship of positive and negative signs among the primary differences d1, d2, d3 and the secondary differences d4, d5.

Also, the judgment as to whether an edge is located between the pixels is not limited to the use of the technique utilizing the difference filter and may be made by use of one of various other techniques. For example, filtering processing on the image S0 may be performed by use of a Sorbel filter, a Laplacian filter, or the like, and an edge may thereby be detected. Alternatively, the filtering processing with the difference filter illustrated in FIG. 4 may be performed on only the two pixels that are adjacent to each other, the difference may thereby be calculated, a judgment may be made as to whether the absolute value of the thus calculated difference is or is not equal to at least the predetermined threshold value, and the edge detection may thus be performed.

Further, in the image size enlarging and reducing apparatus of FIG. 1, in which the embodiment of the image interpolation apparatus in accordance with the present invention is employed, in cases where it has been judged that an edge is not located, the pixel value of the interpolated pixel P is calculated with the bicubic technique and from the pixel values of the 16 pixels (the four pixels in the one-dimensional direction) located in the vicinity of the interpolated pixel P. Alternatively, in such cases, the pixel value of the interpolated pixel P may be calculated from the pixel values of the nine pixels (the three pixels in the one-dimensional direction) or the four pixels (the two pixels in the one-dimensional direction), which are located in the vicinity of the interpolated pixel P. Further, in lieu of the pixel value of the interpolated pixel P being calculated with the one-dimensional interpolating operation performed in the x direction or the y direction, the pixel value of the interpolated pixel P may be calculated with the two-dimensional interpolating operation. Furthermore, in lieu of the bicubic technique, the linear interpolation technique, the nearest neighbor interpolation technique, the bilinear technique, or the like, may be employed in order to calculate the pixel value of the interpolated pixel P.

An image size enlarging and reducing apparatus, in which an embodiment of the edge detecting apparatus in accordance with the present invention is employed, will be described hereinbelow.

FIG. 13 is a block diagram showing an image size enlarging and reducing apparatus, in which an embodiment of the edge detecting apparatus in accordance with the present invention is employed. As illustrated in FIG. 13, the image size enlarging and reducing apparatus, in which an embodiment of the edge detecting apparatus in accordance with the present invention is employed, comprises an input section 11 for accepting the inputs of the image signal S0 and the information representing the enlargement scale factor K for the image signal S0. The image size enlarging and reducing apparatus also comprises a filtering section 12 and a judging section 13. The image size enlarging and reducing apparatus further comprises an edge pattern classifying section 14. The image size enlarging and reducing apparatus still further comprises an interpolating operation section 15 for calculating the pixel value of the interpolated pixel P. The image size enlarging and reducing apparatus also comprises a control section 16 for controlling the operations of the input section 11, the filtering section 12, the judging section 13, the edge pattern classifying section 14, and the interpolating operation section 15.

In the image size enlarging and reducing apparatus of FIG. 13, in which the embodiment of the edge detecting apparatus in accordance with the present invention is employed, as illustrated in FIG. 2, the image represented by the image signal S0 is constituted of the pixels arrayed in two-dimensional directions. (The image represented by the image signal S0 will hereinbelow be also represented by S0.) Also, the x direction and the y direction are defined as illustrated in FIG. 2.

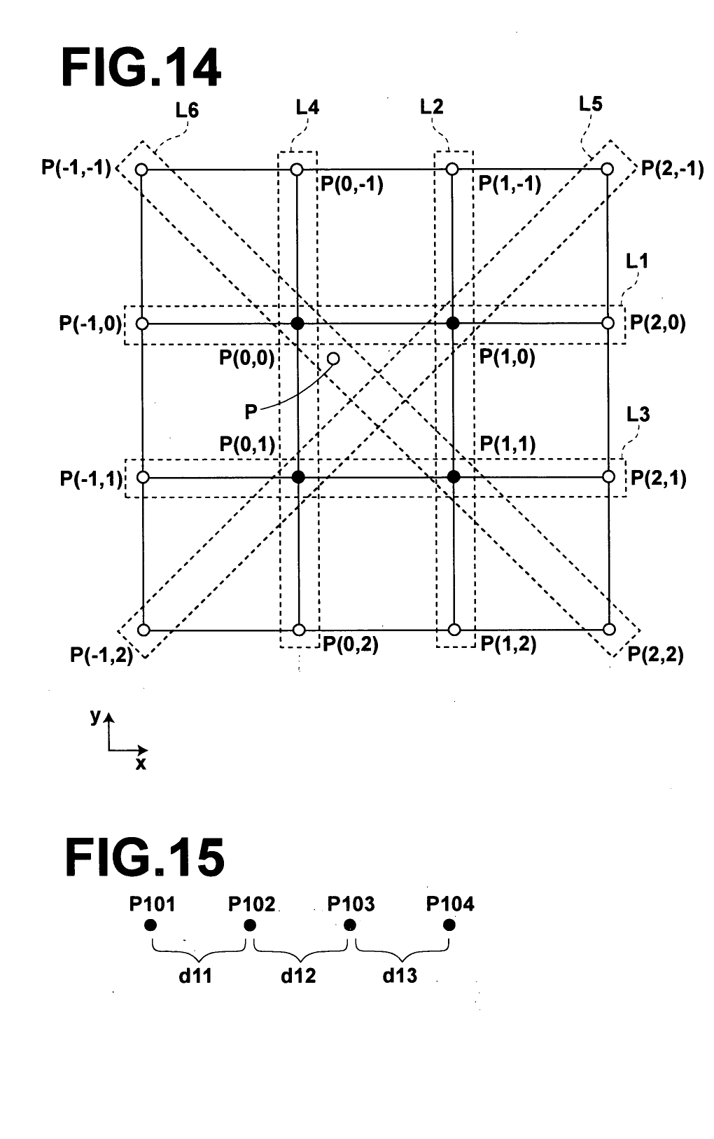

With respect to an array of 16 pixels (=4×4 pixels) in the image S0, which pixels are located in the vicinity of a pixel to be interpolated for image size enlargement or reduction processing, the filtering section 12 sets six pixel lines, each of which passes through two pixels among four middle pixels (=2×2 middle pixels). (The pixel to be interpolated for the image size enlargement or reduction processing will hereinbelow be referred to as the interpolated pixel P.) FIG. 14 is an explanatory view showing pixel lines, each of which passes through two pixels among four middle pixels in an array of 16 pixels that are located in the vicinity of a pixel to be interpolated. As illustrated in FIG. 14, with respect to an array of 16 pixels P(i, j), where i=−1 to 2 and j=−1 to 2, which pixels are located in the vicinity of the interpolated pixel P, the filtering section 12 sets six pixel lines L1, L2, L3, L4, L5, and L6, each of which passes through two pixels among the four middle pixels P(0, 0), P(1, 0), P(1, 1), and P(0, 1) that are indicated by the black dots.

Specifically, the pixel line L1 is constituted of the pixels P(−1, 0), P(0, 0), P(1, 0), and P(2, 0). The pixel line L2 is constituted of the pixels P(1, −1), P(1, 0), P(1, 1), and P(1, 2). The pixel line L3 is constituted of the pixels P(−1, 1), P(0, 1), P(1, 1), and P(2, 1). The pixel line L4 is constituted of the pixels P(0, −1), P(0, 0), P(0, 1), and P(0, 2). The pixel line L5 is constituted of the pixels P(2, −1), P(1, 0), P(0, 1), and P(−1, 2). The pixel line L6 is constituted of the pixels P(−1, −1), P(0, 0), P(1, 1), and P(2, 2) Each of the pixel line L1 and the pixel line L3 is constituted of the four pixels, which stand side by side in the x direction. Each of the pixel line L2 and the pixel line L4 is constituted of the four pixels, which stand side by side in the y direction. The pixel line L5 is constituted of the four pixels, which stand side by side in the direction extending from the upper right point toward the lower left point. The pixel line L6 is constituted of the four pixels, which stand side by side in the direction extending from the upper left point toward the lower right point.

With respect to each of the pixel lines L1 to L6, the filtering section 12 performs the filtering processing with the difference filter and on each of three pixel pairs, each of the three pixel pairs being constituted of the two pixels, which are adjacent to each other. In this manner, three difference values are calculated. FIG. 15 is an explanatory view showing how the filtering processing is performed in the filtering section 12. The four pixels constituting each of the pixel lines L1 to L6 will hereinbelow be represented by P101, P102, P103, and P104. As illustrated in FIG. 15, with respect to the four pixels P101, P102, P103, and P104, which constitute each of the pixel lines L1 to L6, the filtering section 12 performs the filtering processing with the difference filter, which is illustrated in FIG. 4, and on each of the three pixel pairs, each of the three pixel pairs being constituted of the two pixels, which are adjacent to each other, i.e. on each of a pixel pair of P101 and P102, a pixel pair of P102 and P103, and a pixel pair of P103 and P104. The filtering section 12 thereby obtains a difference d11 between the pixel values of the pixel pair of P101 and P102. The filtering section 12 also obtains a difference d12 between the pixel values of the pixel pair of P102 and P103. The filtering section 12 further obtains a difference d13 between the pixel values of the pixel pair of P103 and P104.

With respect to each of the pixel lines L1 to L6, the judging section 13 makes a judgment (i.e., a third judgment) as to whether the absolute value |d12| of the difference d12 between the middle pixel pair of P102 and P103 is or is not equal to at least a predetermined threshold value Th2. In cases where it has been judged with the third judgment that the absolute value |d12| of the difference d12 between the middle pixel pair of P102 and P103 is equal to at least the predetermined threshold value Th2, the judging section 13 judges that an edge is located between the pixels P102 and P103. The judging section 13 also feeds the information, which represents the result of the judgment, into the edge pattern classifying section 14.

In cases where it has been judged with the third judgment that the absolute value |d12| of the difference d12 between the middle pixel pair of P102 and P103 is not equal to at least the predetermined threshold value Th2, with respect to each of the pixel lines L1 to L6, the judging section 13 makes a judgment (i.e., a fourth judgment) as to whether or not the absolute value |d12| of the difference d12 between the middle pixel pair of P102 and P103 is equal to at least a predetermined threshold value Th3, which is smaller than the threshold value Th2, and at the same time the absolute value |d12| of the difference d12 is the maximum value among the absolute values |d11| to |d13| of the differences d11 to d13. In cases where it has been judged with the fourth judgment that the absolute value |d12| of the difference d12 between the middle pixel pair of P102 and P103 is equal to at least the predetermined threshold value Th3, and at the same time the absolute value |d12| of the difference d12 is the maximum value among the absolute values |d11| to |d13| of the differences d11 to d13, the judging section 13 judges that an edge is located between the pixels P102 and P103. The judging section 13 also feeds the information, which represents the result of the judgment, into the edge pattern classifying section 14. In cases where it has been judged with the fourth judgment that the absolute value |d12| of the difference d12 between the middle pixel pair of P102 and P103 is not equal to at least the predetermined threshold value Th3, and that the absolute value |d12| of the difference d12 is not the maximum value among the absolute values |d11| to |d13| of the differences d11 to d13, the judging section 13 judges that an edge is not located between the pixels P102 and P103. The judging section 13 also feeds the information, which represents the result of the judgment, into the edge pattern classifying section 14.

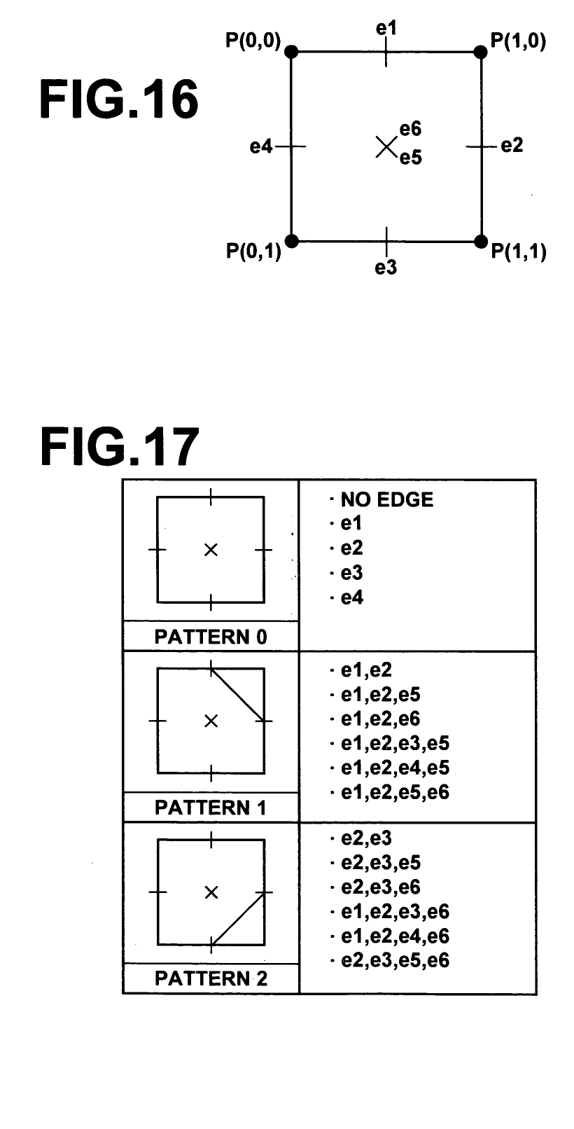

In accordance with the results of the judgments having been made by the judging section 13, the edge pattern classifying section 14 makes a judgment as to between which pixels among the pixels P(0, 0), P(1, 0), P(1, 1), and P(0, 1) an edge is located. Specifically, as illustrated in FIG. 16, the edge pattern classifying section 14 makes a judgment as to whether an edge is or is not located in an area e1 between the pixels P(0, 0) and P(1, 0), an area e2 between the pixels P(1, 0) and P(1, 1), an area e3 between the pixels P(1, 1) and P(0, 1), an area e4 between the pixels P(0, 1) and P(0, 0), an area e5 between the pixels P(1, 0) and P(0, 1), and an area e6 between the pixels P(0, 0) and P(1, 1).

In cases where it has been judged that an edge is located on the pixel line L1, the edge pattern classifying section 14 judges that the edge is located in the area e1. In cases where it has been judged that an edge is located on the pixel line L2, the edge pattern classifying section 14 judges that the edge is located in the area e2. In cases where it has been judged that an edge is located on the pixel line L3, the edge pattern classifying section 14 judges that the edge is located in the area e3. In cases where it has been judged that an edge is located on the pixel line L4, the edge pattern classifying section 14 judges that the edge is located in the area e4. In cases where it has been judged that an edge is located on the pixel line L5, the edge pattern classifying section 14 judges that the edge is located in the area e5. Also, in cases where it has been judged that an edge is located on the pixel line L6, the edge pattern classifying section 14 judges that the edge is located in the area e6.

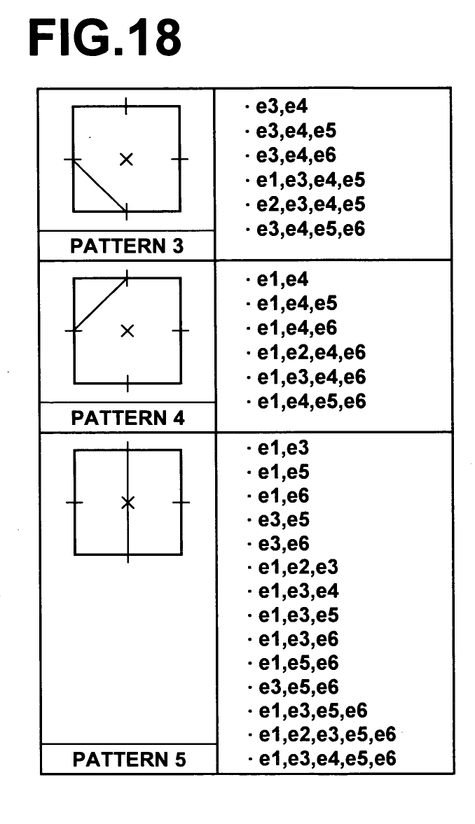

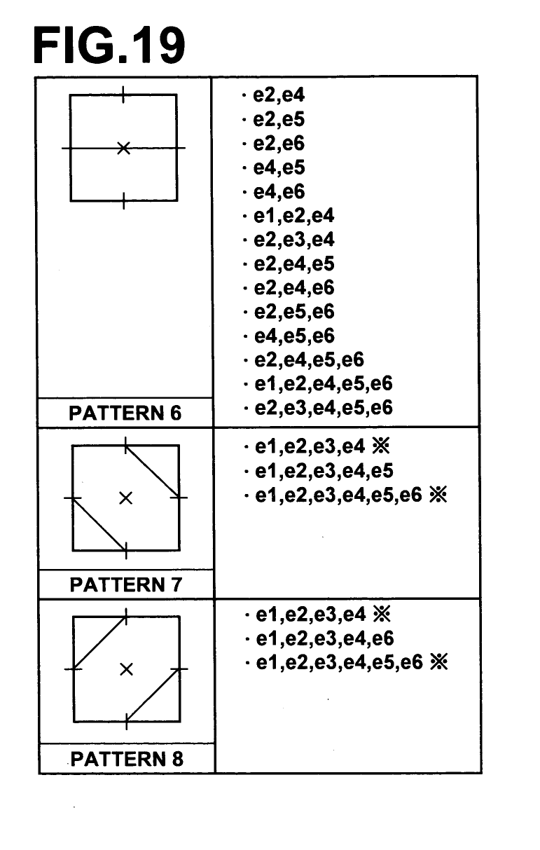

Further, the edge pattern classifying section 14 classifies edge patterns in accordance with the straight line connecting the median points between the pixels, between which it has been judged that an edge is located. FIG. 17, FIG. 18, and FIG. 19 are tables showing various examples of edge patterns in accordance with locations of edges. As illustrated in FIG. 17, FIG. 18, and FIG. 19, the edge patterns are classified into nine kinds of edge patterns, i.e. a pattern 0 to a pattern 8.

In cases where it has been judged that an edge is located in the area e1, the area e2, the area e3, and the area e4, and in cases where it has been judged that an edge is located in the area e1, the area e2, the area e3, and the area e4, the area e5, and the area e6, it is not capable of being found directly whether the edge pattern is to be classified as the pattern 7 or the pattern 8. Therefore, in cases where it has been judged that an edge is located in the area e1, the area e2, the area e3, and the area e4, and in cases where it has been judged that an edge is located in the area e1, the area e2, the area e3, and the area e4, the area e5, and the area e6, the edge pattern classifying section 14 calculates the absolute value |d11| of the difference d11 between the pixel values of the pixel P(0, 0) and the pixel P(1, 1), and the absolute value |d12| of the difference d12 between the pixel values of the pixel P(0, 1) and the pixel P(1, 0) In cases where |d11|<|d12|, the edge pattern classifying section 14 classifies the edge pattern as the pattern 7. In cases where |d11|>|d12|, the edge pattern classifying section 14 classifies the edge pattern as the pattern 8.

Furthermore, the edge pattern classifying section 14 feeds the information, which represents the result of the classification of the edge pattern, into the interpolating operation section 15.

The interpolating operation section 15 makes reference to the information, which represents the result of the classification of the edge pattern having been performed by the edge pattern classifying section 14. Also, the interpolating operation section 15 performs different interpolating operations for the cases where it has been judged that an edge is located within the area surrounded by the four pixels, which are adjacent to the interpolated pixel P, and the cases where it has been judged that an edge is not located within the area surrounded by the four pixels, which are adjacent to the interpolated pixel P. The interpolating operation section 15 thus calculates the pixel value of the interpolated pixel P. Specifically, in cases where it has been judged that an edge is not located within the area surrounded by the four pixels, which are adjacent to the interpolated pixel P, the interpolating operation section 15 performs the bicubic technique having been described above with reference to FIG. 9 and thus calculates the pixel value of the interpolated pixel P.

In cases where it has been judged that an edge is located within the area surrounded by the four pixels, which are adjacent to the interpolated pixel P, the interpolating operation section 15 calculates the pixel value of the interpolated pixel P in accordance with the edge pattern within the area surrounded by the four pixels, which are other than the aforesaid four pixels that are adjacent to the interpolated pixel P. Specifically, the interpolating operation section 15 detects the edge pattern within the region of the array of the 16 pixels (=4×4 pixels), which are located in the vicinity of the interpolated pixel P, by making reference to the edge pattern within the area surrounded by the four pixels P(−1, −1), P(0, −1), P(0, 0), and P(−1, 0), the edge pattern within the area surrounded by the four pixels P(0, −1), P(1, −1), P(1, 0), and P(0, 0), the edge pattern within the area surrounded by the four pixels P(1, −1), P(2, −1), P(2, 0), and P(1, 0), the edge pattern within the area surrounded by the four pixels P(−1, 0), P(0, 0), P(0, 1), and P(−1, 1), the edge pattern within the area surrounded by the four pixels P(1, 0), P(2, 0), P(2, 1), and P(1, 1), the edge pattern within the area surrounded by the four pixels P(−1, 1), P(0, 1), P(0, 2), and P(−1, 2), the edge pattern within the area surrounded by the four pixels P(0, 1), P(1, 1), P(1, 2), and P(0, 2), and the edge pattern within the area surrounded by the four pixels P(1, 1), P(2, 1), P(2, 2), and P(1, 2).

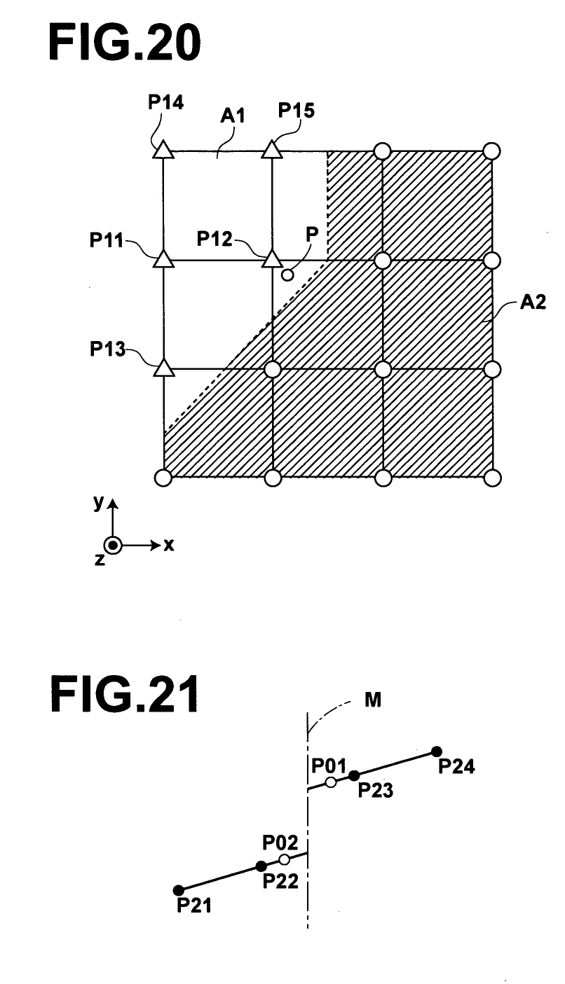

The edge pattern within the region of the array of the 16 pixels, which are located in the vicinity of the interpolated pixel P, takes the pattern indicated by the broken line in FIG. 20 in cases where the edge pattern within the area surrounded by the four pixels, which are adjacent to the interpolated pixel P, coincides with the pattern 4, the edge pattern within the area surrounded by the four pixels P(−1, −1), P(0, −1), P(0, 0), and P(−1, 0) coincides with the pattern 0, the edge pattern within the area surrounded by the four pixels P(0, −1), P(1, −1), P(1, 0), and P(0, 0) coincides with the pattern 5, the edge pattern within the area surrounded by the four pixels P(1, −1), P(2, −1), P(2, 0), and P(1, 0) coincides with the pattern 0, the edge pattern within the area surrounded by the four pixels P(−1, 0), P(0, 0), P(0, 1), and P(−1, 1) coincides with the pattern 2, the edge pattern within the area surrounded by the four pixels P(1, 0), P(2, 0), P(2, 1), and P(1, 1) coincides with the pattern 0, the edge pattern within the area surrounded by the four pixels P(−1, 1), P(0, 1), P(0, 2), and P(−1, 2) coincides with the pattern 4, the edge pattern within the area surrounded by the four pixels P(0, 1), P(1, 1), P(1, 2), and P(0, 2) coincides with the pattern 0, and the edge pattern within the area surrounded by the four pixels P(1, 1), P(2, 1), P(2, 2), and P(1, 2) coincides with the pattern 0. As illustrated in FIG. 20, the region of the array of the 16 pixels is divided by the edge into two subregions A1 and A2. In FIG. 20, the subregion A2 is hatched.

The interpolating operation section 15 selects the pixels, which are to be utilized for the interpolating operation, in accordance with the edge pattern within the region of the array of the 16 pixels and in accordance with whether the interpolated pixel P is located on one side of the edge or on the other side of the edge. For example, as illustrated in FIG. 20, in cases where the interpolated pixel P is located on the side of the subregion A1, the interpolating operation section 15 calculates the pixel value of the interpolated pixel P by use of only the pixels P11, P12, P13, P14, and P15 (indicated by “A” in FIG. 20), which are located on the side of the subregion A1. Also, in cases where the interpolated pixel P is located on the side of the subregion A2, the interpolating operation section 15 calculates the pixel value of the interpolated pixel P by use of only the pixels (indicated by “◯” in FIG. 20), which are located on the side of the subregion A2.

FIG. 21 shows a profile of the pixel values obtained in cases where an edge is located between the two middle pixels among the four pixels, which are arrayed in series. In FIG. 21, the horizontal direction represents the direction in which the pixels are arrayed, and the vertical direction represents the direction representing the levels of the pixel values of the pixels. As illustrated in FIG. 21, it is herein assumed that an edge has been judged as being located between two middle pixels P22 and P23 among four pixels P21, P22, P23, and P24, which are adjacent in series to one another.

In such cases, the median line M, which is indicated by the single-dot chained line and which bisects the distance between the pixels P22 and P23 in the pixel array direction, is set. In cases where the interpolated pixel P is located on the right side of the median line M (in this case, the interpolated pixel P is represented by P01), a value lying on the extension of the straight line, which connects the pixels P23 and P24, is taken as the pixel value of the interpolated pixel P01. Also, in cases where the interpolated pixel P is located on the left side of the median line M (in this case, the interpolated pixel P is represented by P02), a value lying on the extension of the straight line, which connects the pixels P21 and P22, is taken as the pixel value of the interpolated pixel P02.

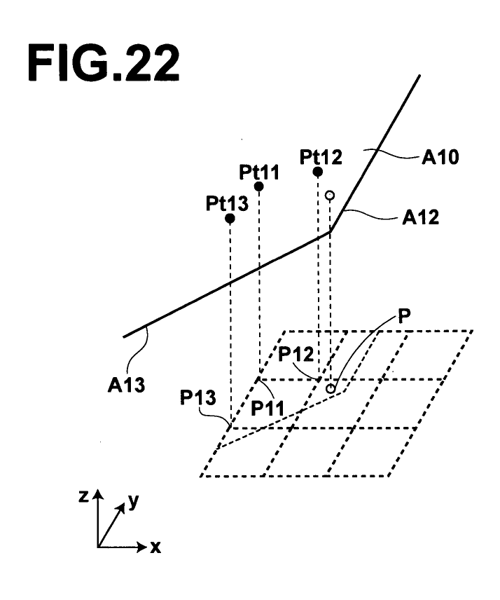

In the image size enlarging and reducing apparatus of FIG. 13, in which the embodiment of the edge detecting apparatus in accordance with the present invention is employed, the interpolating operation described above is applied to two-dimensional directions, and the pixel value of the interpolated pixel P is thus calculated, Specifically, as illustrated in FIG. 22, a pixel position is represented by the x coordinate and the y coordinate. Also, a pixel value is represented by the z coordinate. In the three-dimensional space having the x, y, and z coordinate axes, a plane A10, which passes through the z coordinates of the pixel values Pt11, Pt12, and Pt13 of the three pixels P11, P12, and P13 (shown in FIG. 20), respectively, which are located on the side of the subregion A1, is set. In the plane A10, a side A12 and a side A13 correspond to the position of the edge. Further, a value of the z coordinate, which corresponds to the x and y coordinates of the interpolated pixel P, in the plane A10 is taken as the pixel value of the interpolated pixel P.

The technique for calculating the pixel value of the interpolated pixel P is not limited to the technique described above. For example, an interpolating operation may be employed, wherein a comparatively large weight factor is given to a pixel, which is located at a position close to the interpolated pixel P, and a comparatively small weight factor is given to a pixel, which is located at a position remote from the interpolated pixel P. Specifically, a weight factor W11 for the pixel P11, a weight factor W12 for the pixel P12, a weight factor W13 for the pixel P13, a weight factor W14 for the pixel P14, and a weight factor W15 for the pixel P15 may be set such that the weight factor W12 for the pixel P12, which is located at the position closest to the interpolated pixel P, may be largest. Also, the operation processing with Formula (6) shown below may be performed on the pixel values Pt11, Pt12, Pt13, Pt14, and Pt15 of the pixels P11, P12, P13, P14, and P15, respectively. In this manner, the pixel value (herein represented by Pt) of the interpolated pixel P may be calculated.

$$Pt = {\sum }_{i = 1}^{5} W1i \cdot Pt1i where {\sum }_{i = 1}^{5} W1i = 1 \qquad ( 6 )$$

The operation processing performed in cases where it has been judged that an edge is located between the two pixels will hereinbelow be referred to as the third interpolating operation. Also, the operation processing performed in cases where it has been judged that an edge is not located between the two pixels will hereinbelow be referred to as the fourth interpolating operation.

How the processing is performed in the image size enlarging and reducing apparatus of FIG. 13, in which the embodiment of the edge detecting apparatus in accordance with the present invention is employed, will be described hereinbelow.

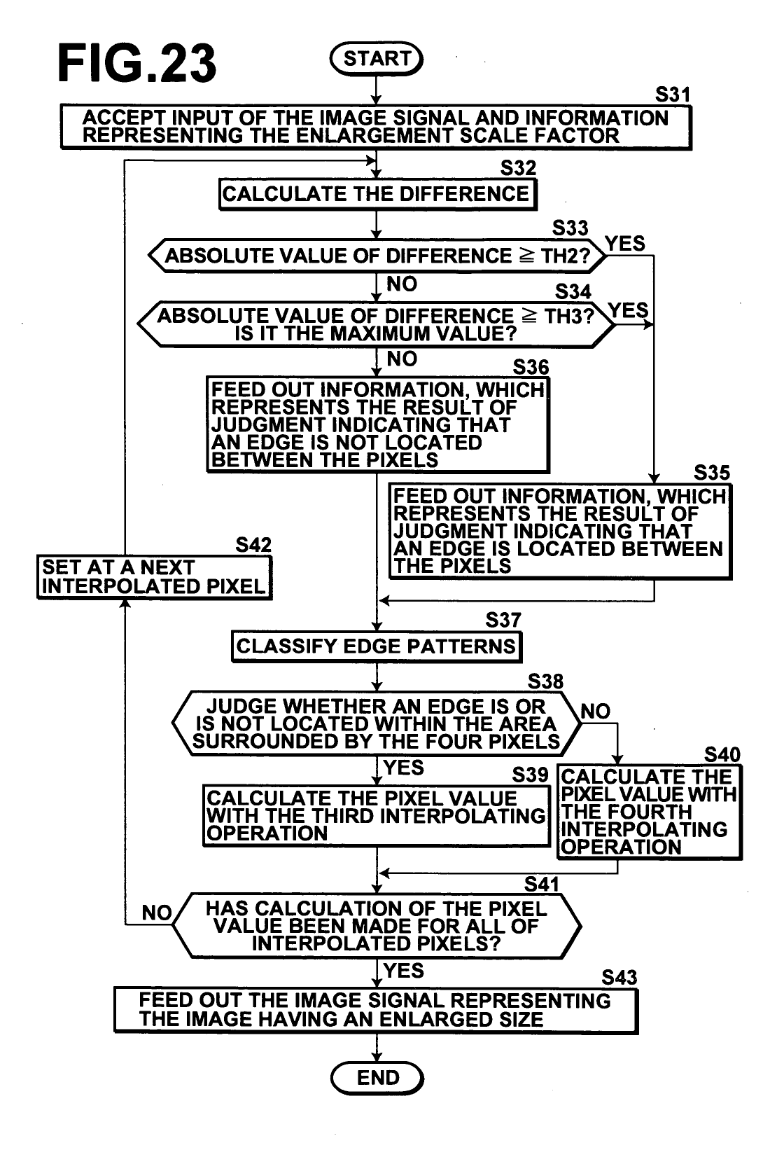

FIG. 23 is a flow chart showing how processing is performed in the image size enlarging and reducing apparatus of FIG. 13, in which the embodiment of the edge detecting apparatus in accordance with the present invention is employed. In this embodiment, it is assumed that the interpolated pixel P is located between the pixels in the image S0. Firstly, in a step S31, the input section 11 accepts the image signal S0, which is to be subjected to the image size enlargement processing, and the information representing the enlargement scale factor K for the image signal S0. Also, in a step S32, with respect to a first interpolated pixel P in accordance with the enlargement scale factor K (for example, a pixel located in an upper left area of the image S1 represented by the image signal S1 obtained from the image size enlargement processing), the filtering section 12 sets the pixel lines L1 to L6 for the 16 pixels, which are located in the vicinity of the interpolated pixel P. Also, with respect to each of the pixel lines L1 to L6, the filtering section 12 performs the filtering processing with the difference filter and on each of the three pixel pairs, each of the three pixel pairs being constituted of the two pixels, which are adjacent to each other. The filtering section 12 thus calculates the three differences d11, d12, and d13 for each of the pixel lines L1 to L6.

Thereafter, in a step S33, with respect to each of the pixel lines L1 to L6, the judging section 13 makes the judgment (i.e., the third judgment) as to whether the absolute value |d12| of the difference d12 between the middle pixel pair of P102 and P103 is or is not equal to at least the predetermined threshold value Th2. In cases where it has been judged with the third judgment in the step S33 that the absolute value |d12| of the difference d12 between the middle pixel pair of P102 and P103 is not equal to at least the predetermined threshold value Th2, in a step S34, the judging section 13 makes the judgment (i.e., the fourth judgment) as to whether or not the absolute value |d12| of the difference d12 between the middle pixel pair of P102 and P103 is equal to at least the predetermined threshold value Th3, which is smaller than the threshold value Th2, and at the same time the absolute value |d12| of the difference d12 is the maximum value among the absolute values |d11| to |d13| of the differences d11 to d13.

In cases where it has been judged with the third judgment in the step S33 that the absolute value |d12| of the difference d12 between the middle pixel pair of P102 and P103 is equal to at least the predetermined threshold value Th2, and in cases where it has been judged with the fourth judgment in the step S34 that the absolute value |d12| of the difference d12 between the middle pixel pair of P102 and P103 is equal to at least the predetermined threshold value Th3, which is smaller than the threshold value Th2, and at the same time the absolute value |d12| of the difference d12 is the maximum value among the absolute values |d11| to |d13| of the differences d11 to d13, in a step S35, the judging section 13 judges that an edge is located between the two middle pixels P102 and P103 on each of the pixel lines L1 to L6. The judging section 13 also feeds the information, which represents the result of the judgment indicating that an edge is located between the pixels, into the edge pattern classifying section 14. In cases where it has been judged with the fourth judgment in the step S34 that the absolute value |d12| of the difference d12 between the middle pixel pair of P102 and P103 is not equal to at least the predetermined threshold value Th3, which is smaller than the threshold value Th2, and the absolute value |d12| of the difference d12 is not the maximum value among the absolute values |d11| to |d13| of the differences d11 to d13, in a step S36, the judging section 13 feeds the information, which represents the result of the judgment indicating that an edge is not located between the pixels, into the edge pattern classifying section 14.

In a step S37, the edge pattern classifying section 14 receives the information, which represents the results of the judgments having been made by the judging section 13, and classifies the edge patterns in accordance with the results of the judgments. Also, the edge pattern classifying section 14 feeds the information, which represents the result of the classification of the edge pattern, into the interpolating operation section 15.

In a step S38, in accordance with the result of the classification of the edge pattern having been performed by the edge pattern classifying section 14, the interpolating operation section 15 makes a judgment as to whether the edge pattern coincides or does not coincide with the pattern 0 shown in FIG. 17, and thus makes a judgment as to whether an edge is or is not located within the area surrounded by the four pixels, which are adjacent to the interpolated pixel P. In cases where it has been judged in the step S38 that an edge is located within the area surrounded by the four pixels, which are adjacent to the interpolated pixel P, in a step S39, the interpolating operation section 15 performs the third interpolating operation described above and thus calculates the pixel value of the interpolated pixel P. In cases where it has been judged in the step S38 that an edge is not located within the area surrounded by the four pixels, which are adjacent to the interpolated pixel P, in a step S40, the interpolating operation section 15 performs the fourth interpolating operation described above and thus calculates the pixel value of the interpolated pixel P.

Further, in a step S41, the control section 16 makes a judgment as to whether the calculation of the pixel value of the interpolated pixel P has been or has not been made with respect to all of interpolated pixels P, P, . . . In cases where it has been judged in the step S41 that the calculation of the pixel value of the interpolated pixel P has not been made with respect to all of interpolated pixels P, P, . . . , in a step S42, the interpolated pixel P to be subjected to the calculation of the pixel value is set at a next interpolated pixel P. Also, the processing reverts to the step S32.

In cases where it has been judged in the step S41 that the calculation of the pixel value of the interpolated pixel P has been made with respect to all of interpolated pixels P, P, . . . , in a step S43, the image signal S1, which represents the image S1 containing the interpolated pixels P, P, . . . and having an enlarged size, is fed out. At this stage, the processing is finished.

As described above, in the image size enlarging and reducing apparatus of FIG. 13, in which the embodiment of the edge detecting apparatus in accordance with the present invention is employed, the pixel lines L1 to L6, each of which is constituted of the four pixels that are arrayed in series, are set with respect to the array of the 16 pixels (=4×4 pixels), which are located in the vicinity of the interpolated pixel P. Further, with respect to each of the pixel lines L1 to L6, the judgment is made as to whether an edge is located between the two middle pixels. In cases where it has been judged with the third judgment that the absolute value of the difference between the pixel values of the two middle pixels is equal to at least the threshold value Th2, it is regarded that an edge is located between the two middle pixels. Therefore, instead of a detection being made as to whether an edge is or is not located at a pixel in the image S0, the detection is capable of being made as to whether an edge is or is not located between the pixels in the image S0. Also, since it is sufficient for the differences to be calculated, the detection as to whether an edge is or is not located between the pixels in the image is capable of being made quickly with simple operation processing.

Further, in cases where it has been judged with the third judgment that an edge is not located between the two middle pixels, the judgment (i.e., the fourth judgment) is made as to whether or not the absolute value of the difference between the two middle pixels is equal to at least the predetermined threshold value Th3, which is smaller than the threshold value Th2, and at the same time the absolute value of the difference between the two middle pixels is the maximum value among the absolute values of the differences among the four pixels, which are arrayed in series. In cases where it has been judged with the fourth judgment that the absolute value of the difference between the two middle pixels is equal to at least the predetermined threshold value Th3, which is smaller than the threshold value Th2, and at the same time the absolute value of the difference between the two middle pixels is the maximum value among the absolute values of the differences among the four pixels, which are arrayed in series, it is regarded that an edge is located between the two middle pixels. Therefore, the problems are capable of being prevented from occurring in that a true edge is judged as being not an edge. Accordingly, an edge located between the pixels is capable of being detected accurately.

Furthermore, in the image size enlarging and reducing apparatus of FIG. 13, in which the embodiment of the edge detecting apparatus in accordance with the present invention is employed, in accordance with the results of the aforesaid judgments having been made as to whether an edge is or is not located between the two middle pixels among the four pixels, which are arrayed in series, the judgment is made as to whether an edge is or is not located within the area surrounded by the four pixels (=2×2 pixels), which are located in the vicinity of the interpolated pixel P. Therefore, an edge, which is located between the four pixels (=2×2 pixels) adjacent to one another in the image, is capable of being detected accurately.

Also, in the image size enlarging and reducing apparatus of FIG. 13, in which the embodiment of the edge detecting apparatus in accordance with the present invention is employed, in cases where it has been judged that an edge is located within the area surrounded by the four pixels (=2×2 pixels), which are located in the vicinity of the interpolated pixel P, the edge pattern within the area surrounded by the four pixels is classified in accordance with the position, at which an edge has been detected. Therefore, the pattern of the edge is capable of being classified accurately.

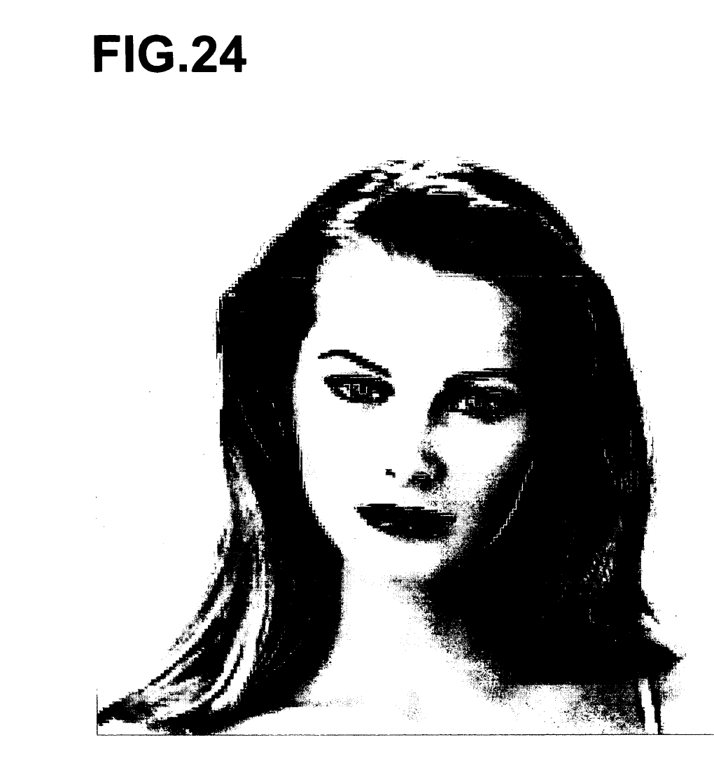

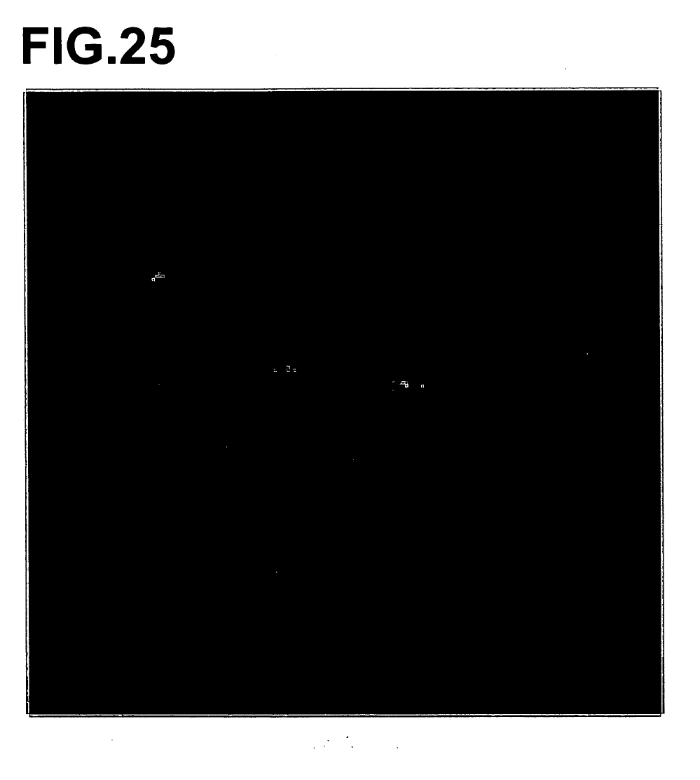

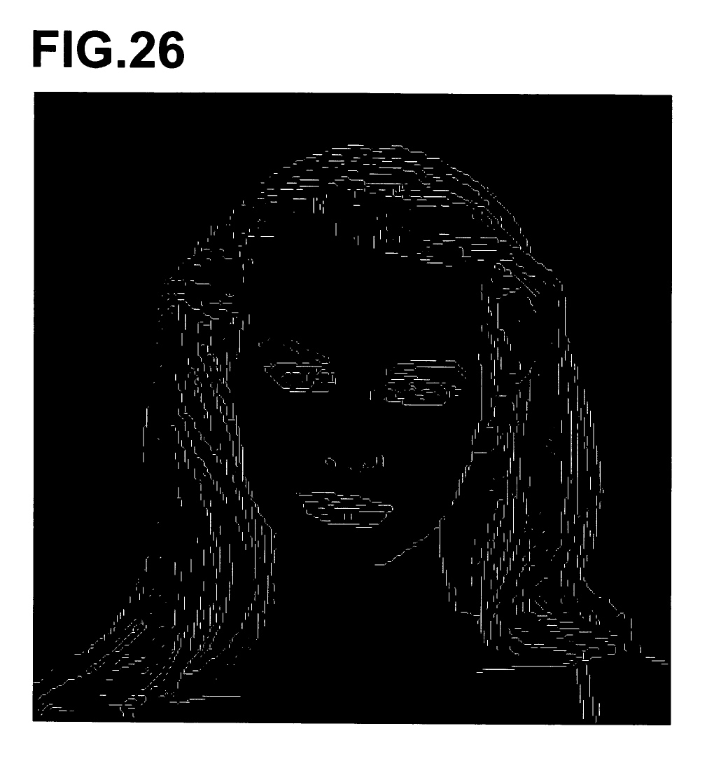

FIG. 24 is a view showing a sample image. FIG. 25 is a view showing a result of detection of edges with a Laplacian filter. FIG. 26 is a view showing a result of detection of edges with the technique in accordance with the present invention. With the Laplacian filter, a judgment is made as to whether a pixel of interest constitutes or does not constitute en edge. Therefore, as for the sample image illustrated in FIG. 24, in cases where the edge detection is performed by use of the conventional Laplacian filter, as illustrated in FIG. 25, edges representing a face contour are capable of being detected, but the detected lines become markedly thick. However, in cases where the edge detection is performed with the image size enlarging and reducing apparatus of FIG. 13, in which the embodiment of the edge detecting apparatus in accordance with the present invention is employed, it is possible to detect what edge extending in what orientation is located between the pixels. Therefore, as illustrated in FIG. 26, edges are capable of being represented by the markedly thin lines. Accordingly, the edges and non-edge areas are capable of being discriminated clearly, and the calculation of the pixel value of the interpolated pixel P is capable of being made accurately.

In the image size enlarging and reducing apparatus of FIG. 13, in which the embodiment of the edge detecting apparatus in accordance with the present invention is employed, at the time of the judgment as to whether an edge is located between the two middle pixels on each of the pixel lines L1 to L6, in cases where it has been judged with the third judgment that an edge is not located between the two middle pixels, the fourth judgment is further made in order to judge whether an edge is present or absent. Alternatively, in cases where it has been judged with the third judgment that an edge is not located between the two middle pixels, instead of the fourth judgment being made, it may be judged that an edge is not located between the two middle pixels. As another alternative, the absolute values of the three differences calculated with respect to the four pixels, which are arrayed in series on each of the pixel lines L1 to L6, may be compared with one another, and it may be judged that an edge is located between the two middle pixels in cases where the absolute value of the difference between the two middle pixels is the maximum value among the absolute values of the three differences.

Also, in the image size enlarging and reducing apparatus of FIG. 13, in which the embodiment of the edge detecting apparatus in accordance with the present invention is employed, in cases where it has been judged that an edge is not located within the area surrounded by the four pixels, the pixel value of the interpolated pixel P is calculated with the bicubic technique and from the pixel values of the 16 pixels located in the vicinity of the interpolated pixel P. Alternatively, in such cases, the pixel value of the interpolated pixel P may be calculated from the pixel values of the nine pixels or the four pixels, which are located in the vicinity of the interpolated pixel P. Further, in lieu of the bicubic technique, the linear interpolation technique, the nearest neighbor interpolation technique, the bilinear technique, or the like, may be employed in order to calculate the pixel value of the interpolated pixel P.

Further, in the image size enlarging and reducing apparatus of FIG. 13, in which the embodiment of the edge detecting apparatus in accordance with the present invention is employed, the judgment as to whether an edge is located between the two pixels, which are adjacent to each other among the four pixels located in the vicinity of the interpolated pixel P, and the classification of the edge pattern within the area surrounded by the four pixels, which are located in the vicinity of the interpolated pixel P, are performed by the utilization of the 16 pixels (=4×4 pixels), which are located in the vicinity of the interpolated pixel P. Alternatively, the judgment as to whether an edge is located between the two pixels and the classification of the edge pattern may be performed by the utilization of 36 pixels (=6×6 pixels) or a larger number of pixels, which are arrayed such that the number of pixels on one side is an even number.

1. An image interpolation apparatus for interpolating a new pixel between pixels in an image at the time of image size enlargement or reduction processing, the apparatus comprising:
i) boundary setting means for operating such that, in cases where it has been detected that an edge is located between the pixels, between which the new pixel is to be interpolated, the boundary setting means sets a predetermined boundary between the pixels, between which the new pixel is to be interpolated,
ii) judgment means for making a judgment as to whether a position of the new pixel to be interpolated is located on one side of the predetermined boundary or is located on the other side of the predetermined boundary, and
iii) interpolating operation means for operating such that:
a) in cases where it has been judged that the position of the new pixel is located on the one side of the predetermined boundary,
the interpolating operation means performs an interpolating operation by use of a pixel value of at least one pixel, which is located on the one side of the predetermined boundary in the image, in order to calculate a pixel value of the new pixel, and
b) in cases where it has been judged that the position of the new pixel is located on the other side of the predetermined boundary,
the interpolating operation means performs an interpolating operation by use of the pixel value of at least one pixel, which is located on the other side of the predetermined boundary in the image, in order to calculate a pixel value of the new pixel.

2. An image interpolation apparatus as defined in claim 1 wherein the predetermined boundary is a line bisecting the distance between the pixels, between which the new pixel is to be interpolated.

3. An image interpolation method for interpolating a new pixel between pixels in an image at the time of image size enlargement or reduction processing, the method comprising the steps of:
i) operating such that, in cases where it has been detected that an edge is located between the pixels, between which the new pixel is to be interpolated,
a predetermined boundary is set between the pixels, between which the new pixel is to be interpolated,
ii) making a judgment as to whether a position of the new pixel to be interpolated is located on one side of the predetermined boundary or is located on the other side of the predetermined boundary, and
iii) performing an interpolating operation such that:
a) in cases where it has been judged that the position of the new pixel is located on the one side of the predetermined boundary,
the interpolating operation is performed by use of a pixel value of at least one pixel, which is located on the one side of the predetermined boundary in the image, in order to calculate a pixel value of the new pixel, and
b) in cases where it has been judged that the position of the new pixel is located on the other side of the predetermined boundary,
the interpolating operation is performed by use of the pixel value of at least one pixel, which is located on the other side of the predetermined boundary in the image, in order to calculate a pixel value of the new pixel.

4. An image interpolation method as defined in claim 3 wherein the predetermined boundary is a line bisecting the distance between the pixels, between which the new pixel is to be interpolated.

5. A computer program for causing a computer to execute an image interpolation method for interpolating a new pixel between pixels in an image at the time of image size enlargement or reduction processing, the computer program comprising the procedures for:
i) operating such that, in cases where it has been detected that an edge is located between the pixels, between which the new pixel is to be interpolated,
a predetermined boundary is set between the pixels, between which the new pixel is to be interpolated,
ii) making a judgment as to whether a position of the new pixel to be interpolated is located on one side of the predetermined boundary or is located on the other side of the predetermined boundary, and
iii) performing an interpolating operation such that:
a) in cases where it has been judged that the position of the new pixel is located on the one side of the predetermined boundary,
the interpolating operation is performed by use of a pixel value of at least one pixel, which is located on the one side of the predetermined boundary in the image, in order to calculate a pixel value of the new pixel, and
b) in cases where it has been judged that the position of the new pixel is located on the other side of the predetermined boundary,
the interpolating operation is performed by use of the pixel value of at least one pixel, which is located on the other side of the predetermined boundary in the image, in order to calculate a pixel value of the new pixel.

6. A computer program as defined in claim 5 wherein the predetermined boundary is a line bisecting the distance between the pixels, between which the new pixel is to be interpolated.

7. An edge detecting apparatus, comprising:
i) filtering means for performing filtering processing with a difference filter and on each of pixel pairs, each of the pixel pairs being constituted of two pixels, which are adjacent to each other and are contained in an even number of pixels that are at least four pixels and are adjacent in series to one another in an image, and thereby obtaining a difference between pixel values of the two pixels, which are adjacent to each other and constitute each of the pixel pairs, a plurality of differences being obtained for the pixel pairs, and
ii) judgment means for operating such that:
a) the judgment means makes a judgment as to whether an absolute value of the difference between the pixel values of the pixel pair constituted of two middle pixels, which are among the even number of the pixels that are adjacent in series to one another in the image, is or is not a maximum value among the absolute values of the differences having been obtained for all of the pixel pairs, and
b) in cases where it has been judged that the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs,
the judgment means judges that an edge is located between the two middle pixels, which are among the even number of the pixels that are adjacent in series to one another in the image.

8. An edge detecting apparatus, comprising:
i) filtering means for performing filtering processing with a difference filter and on each of pixel pairs, each of the pixel pairs being constituted of two pixels, which are adjacent to each other and are contained in an even number of pixels that are at least four pixels and are adjacent in series to one another in an image, and thereby obtaining a difference between pixel values of the two pixels, which are adjacent to each other and constitute each of the pixel pairs, a plurality of differences being obtained for the pixel pairs, and
ii) judgment means for operating such that:
a) the judgment means makes a judgment as to whether an absolute value of the difference between the pixel values of the pixel pair constituted of two middle pixels, which are among the even number of the pixels that are adjacent in series to one another in the image, is or is not equal to at least a predetermined threshold value, and
b) in cases where it has been judged that the absolute value of the difference between the pixel values of the pixel pair constituted of the two middle pixels, which are among the even number of the pixels that are adjacent in series to one another in the image, is equal to at least the predetermined threshold value,
the judgment means judges that an edge is located between the two middle pixels, which are among the even number of the pixels that are adjacent in series to one another in the image.

9. An edge detecting apparatus as defined in claim 8 wherein the judgment means operates such that:
a) in cases where it has been judged that the absolute value of the difference between the pixel values of the pixel pair constituted of the two middle pixels, which are among the even number of the pixels that are adjacent in series to one another in the image, is not equal to at least the predetermined threshold value,
the judgment means makes a judgment as to whether or not the absolute value of the difference between the pixel values of the pixel pair constituted of the two middle pixels, which are among the even number of the pixels that are adjacent in series to one another in the image, is equal to at least a threshold value, which is smaller than the predetermined threshold value, and at the same time the absolute value of the difference between the pixel values of the pixel pair constituted of the two middle pixels, which are among the even number of the pixels that are adjacent in series to one another in the image, is a maximum value among the absolute values of the differences having been obtained for all of the pixel pairs, and
b) in cases where it has been judged that the absolute value of the difference between the pixel values of the pixel pair constituted of the two middle pixels, which are among the even number of the pixels that are adjacent in series to one another in the image, is equal to at least the threshold value, which is smaller than the predetermined threshold value, and at the same time the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs,
the judgment means judges that an edge is located between the two middle pixels, which are among the even number of the pixels that are adjacent in series to one another in the image.

10. An edge detecting apparatus as defined in claim 7 wherein, in cases where a judgment is to be made as to whether an edge is or is not located between two pixels, which are adjacent to each other and constitute each of six pixel pairs of interest in an array of four adjacent pixels in an image, the four adjacent pixels being arrayed in a form of 2×2 pixels,
the judgment means takes an even number of pixels that are at least four pixels, which contain the two pixels constituting each of the six pixel pairs of interest in the array of the four adjacent pixels in the image, and which contain pixels adjacent in series to the pixel pair of interest on opposite sides of the pixel pair of interest and symmetrically with respect to the pixel pair of interest, as the even number of the pixels that are at least four pixels and are adjacent in series to one another in the image,
the judgment means takes the two pixels, which constitute each of the six pixel pairs of interest, as the two middle pixels, which are among the even number of the pixels that are adjacent in series to one another in the image, and
the judgment means makes a judgment as to whether an edge is or is not located between the two pixels, which constitute each of the six pixel pairs of interest.

11. An edge detecting apparatus as defined in claim 10 wherein the apparatus further comprises edge pattern classifying means for operating such that:
in cases where an edge has been detected between the two pixels, which constitute one of the six pixel pairs of interest,
the edge pattern classifying means classifies an edge pattern within an area of the array of the four adjacent pixels in the image, the four adjacent pixels being arrayed in the form of 2×2 pixels, in accordance with a position at which the edge has been detected.

12. An edge detecting apparatus as defined in claim 8 wherein, in cases where a judgment is to be made as to whether an edge is or is not located between two pixels, which are adjacent to each other and constitute each of six pixel pairs of interest in an array of four adjacent pixels in an image, the four adjacent pixels being arrayed in a form of 2×2 pixels,
the judgment means takes an even number of pixels that are at least four pixels, which contain the two pixels constituting each of the six pixel pairs of interest in the array of the four adjacent pixels in the image, and which contain pixels adjacent in series to the pixel pair of interest on opposite sides of the pixel pair of interest and symmetrically with respect to the pixel pair of interest, as the even number of the pixels that are at least four pixels and are adjacent in series to one another in the image,
the judgment means takes the two pixels, which constitute each of the six pixel pairs of interest, as the two middle pixels, which are among the even number of the pixels that are adjacent in series to one another in the image, and
the judgment means makes a judgment as to whether an edge is or is not located between the two pixels, which constitute each of the six pixel pairs of interest.

13. An edge detecting apparatus as defined in claim 12 wherein the apparatus further comprises edge pattern classifying means for operating such that:
in cases where an edge has been detected between the two pixels, which constitute one of the six pixel pairs of interest,
the edge pattern classifying means classifies an edge pattern within an area of the array of the four adjacent pixels in the image, the four adjacent pixels being arrayed in the form of 2×2 pixels, in accordance with a position at which the edge has been detected.

14. An edge detecting method, comprising the steps of:
i) performing filtering processing with a difference filter and on each of pixel pairs, each of the pixel pairs being constituted of two pixels, which are adjacent to each other and are contained in an even number of pixels that are at least four pixels and are adjacent in series to one another in an image, a difference between pixel values of the two pixels, which are adjacent to each other and constitute each of the pixel pairs, being obtained from the filtering processing, a plurality of differences being obtained for the pixel pairs, and
ii) performing judgment processing such that:
a) a judgment is made as to whether an absolute value of the difference between the pixel values of the pixel pair constituted of two middle pixels, which are among the even number of the pixels that are adjacent in series to one another in the image, is or is not a maximum value among the absolute values of the differences having been obtained for all of the pixel pairs, and
b) in cases where it has been judged that the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs,
it is judged that an edge is located between the two middle pixels, which are among the even number of the pixels that are adjacent in series to one another in the image.

15. An edge detecting method, comprising the steps of:
i) performing filtering processing with a difference filter and on each of pixel pairs, each of the pixel pairs being constituted of two pixels, which are adjacent to each other and are contained in an even number of pixels that are at least four pixels and are adjacent in series to one another in an image, a difference between pixel values of the two pixels, which are adjacent to each other and constitute each of the pixel pairs, being obtained from the filtering processing, a plurality of differences being obtained for the pixel pairs, and
ii) performing judgment processing such that:
a) a judgment is made as to whether an absolute value of the difference between the pixel values of the pixel pair constituted of two middle pixels, which are among the even number of the pixels that are adjacent in series to one another in the image, is or is not equal to at least a predetermined threshold value, and
b) in cases where it has been judged that the absolute value of the difference between the pixel values of the pixel pair constituted of the two middle pixels, which are among the even number of the pixels that are adjacent in series to one another in the image, is equal to at least the predetermined threshold value,
it is judged that an edge is located between the two middle pixels, which are among the even number of the pixels that are adjacent in series to one another in the image.

16. An edge detecting method as defined in claim 15 wherein the judgment processing is performed such that:
a) in cases where it has been judged that the absolute value of the difference between the pixel values of the pixel pair constituted of the two middle pixels, which are among the even number of the pixels that are adjacent in series to one another in the image, is not equal to at least the predetermined threshold value,
a judgment is made as to whether or not the absolute value of the difference between the pixel values of the pixel pair constituted of the two middle pixels, which are among the even number of the pixels that are adjacent in series to one another in the image, is equal to at least a threshold value, which is smaller than the predetermined threshold value, and at the same time the absolute value of the difference between the pixel values of the pixel pair constituted of the two middle pixels, which are among the even number of the pixels that are adjacent in series to one another in the image, is a maximum value among the absolute values of the differences having been obtained for all of the pixel pairs, and
b) in cases where it has been judged that the absolute value of the difference between the pixel values of the pixel pair constituted of the two middle pixels, which are among the even number of the pixels that are adjacent in series to one another in the image, is equal to at least the threshold value, which is smaller than the predetermined threshold value, and at the same time the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs,
it is judged that an edge is located between the two middle pixels, which are among the even number of the pixels that are adjacent in series to one another in the image.

17. An edge detecting method as defined in claim 14 wherein the judgment processing is performed such that:
in cases where a judgment is to be made as to whether an edge is or is not located between two pixels, which are adjacent to each other and constitute each of six pixel pairs of interest in an array of four adjacent pixels in an image, the four adjacent pixels being arrayed in a form of 2×2 pixels,
an even number of pixels that are at least four pixels, which contain the two pixels constituting each of the six pixel pairs of interest in the array of the four adjacent pixels in the image, and which contain pixels adjacent in series to the pixel pair of interest on opposite sides of the pixel pair of interest and symmetrically with respect to the pixel pair of interest, are taken as the even number of the pixels that are at least four pixels and are adjacent in series to one another in the image,
the two pixels, which constitute each of the six pixel pairs of interest, are taken as the two middle pixels, which are among the even number of the pixels that are adjacent in series to one another in the image, and
a judgment is made as to whether an edge is or is not located between the two pixels, which constitute each of the six pixel pairs of interest.

18. An edge detecting method as defined in claim 17 wherein the method further comprises the step of operating such that:
in cases where an edge has been detected between the two pixels, which constitute one of the six pixel pairs of interest,
an edge pattern within an area of the array of the four adjacent pixels in the image, the four adjacent pixels being arrayed in the form of 2×2 pixels, is classified in accordance with a position at which the edge has been detected.

19. An edge detecting method as defined in claim 15 wherein the judgment processing is performed such that:
in cases where a judgment is to be made as to whether an edge is or is not located between two pixels, which are adjacent to each other and constitute each of six pixel pairs of interest in an array of four adjacent pixels in an image, the four adjacent pixels being arrayed in a form of 2×2 pixels,
an even number of pixels that are at least four pixels, which contain the two pixels constituting each of the six pixel pairs of interest in the array of the four adjacent pixels in the image, and which contain pixels adjacent in series to the pixel pair of interest on opposite sides of the pixel pair of interest and symmetrically with respect to the pixel pair of interest, are taken as the even number of the pixels that are at least four pixels and are adjacent in series to one another in the image,
the two pixels, which constitute each of the six pixel pairs of interest, are taken as the two middle pixels, which are among the even number of the pixels that are adjacent in series to one another in the image, and
a judgment is made as to whether an edge is or is not located between the two pixels, which constitute each of the six pixel pairs of interest.

20. An edge detecting method as defined in claim 19 wherein the method further comprises the step of operating such that:
in cases where an edge has been detected between the two pixels, which constitute one of the six pixel pairs of interest,
an edge pattern within an area of the array of the four adjacent pixels in the image, the four adjacent pixels being arrayed in the form of 2×2 pixels, is classified in accordance with a position at which the edge has been detected.

21. A computer program for causing a computer to execute an edge detecting method, the computer program comprising the procedures for:
i) performing filtering processing with a difference filter and on each of pixel pairs, each of the pixel pairs being constituted of two pixels, which are adjacent to each other and are contained in an even number of pixels that are at least four pixels and are adjacent in series to one another in an image, a difference between pixel values of the two pixels, which are adjacent to each other and constitute each of the pixel pairs, being obtained from the filtering processing, a plurality of differences being obtained for the pixel pairs, and
ii) performing judgment processing such that:
a) a judgment is made as to whether an absolute value of the difference between the pixel values of the pixel pair constituted of two middle pixels, which are among the even number of the pixels that are adjacent in series to one another in the image, is or is not a maximum value among the absolute values of the differences having been obtained for all of the pixel pairs, and
b) in cases where it has been judged that the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs,
it is judged that an edge is located between the two middle pixels, which are among the even number of the pixels that are adjacent in series to one another in the image.

22. A computer program for causing a computer to execute an edge detecting method, the computer program comprising the procedures for:
i) performing filtering processing with a difference filter and on each of pixel pairs, each of the pixel pairs being constituted of two pixels, which are adjacent to each other and are contained in an even number of pixels that are at least four pixels and are adjacent in series to one another in an image, a difference between pixel values of the two pixels, which are adjacent to each other and constitute each of the pixel pairs, being obtained from the filtering processing, a plurality of differences being obtained for the pixel pairs, and
ii) performing judgment processing such that:
a) a judgment is made as to whether an absolute value of the difference between the pixel values of the pixel pair constituted of two middle pixels, which are among the even number of the pixels that are adjacent in series to one another in the image, is or is not equal to at least a predetermined threshold value, and
b) in cases where it has been judged that the absolute value of the difference between the pixel values of the pixel pair constituted of the two middle pixels, which are among the even number of the pixels that are adjacent in series to one another in the image, is equal to at least the predetermined threshold value,
it is judged that an edge is located between the two middle pixels, which are among the even number of the pixels that are adjacent in series to one another in the image.

23. A computer program as defined in claim 22 wherein the procedure for performing the judgment processing is a procedure for operating such that:
a) in cases where it has been judged that the absolute value of the difference between the pixel values of the pixel pair constituted of the two middle pixels, which are among the even number of the pixels that are adjacent in series to one another in the image, is not equal to at least the predetermined threshold value,
a judgment is made as to whether or not the absolute value of the difference between the pixel values of the pixel pair constituted of the two middle pixels, which are among the even number of the pixels that are adjacent in series to one another in the image, is equal to at least a threshold value, which is smaller than the predetermined threshold value, and at the same time the absolute value of the difference between the pixel values of the pixel pair constituted of the two middle pixels, which are among the even number of the pixels that are adjacent in series to one another in the image, is a maximum value among the absolute values of the differences having been obtained for all of the pixel pairs, and
b) in cases where it has been judged that the absolute value of the difference between the pixel values of the pixel pair constituted of the two middle pixels, which are among the even number of the pixels that are adjacent in series to one another in the image, is equal to at least the threshold value, which is smaller than the predetermined threshold value, and at the same time the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs,
it is judged that an edge is located between the two middle pixels, which are among the even number of the pixels that are adjacent in series to one another in the image.

24. A computer program as defined in claim 21 wherein the procedure for performing the judgment processing is a procedure for operating such that:
in cases where a judgment is to be made as to whether an edge is or is not located between two pixels, which are adjacent to each other and constitute each of six pixel pairs of interest in an array of four adjacent pixels in an image, the four adjacent pixels being arrayed in a form of 2×2 pixels,
an even number of pixels that are at least four pixels, which contain the two pixels constituting each of the six pixel pairs of interest in the array of the four adjacent pixels in the image, and which contain pixels adjacent in series to the pixel pair of interest on opposite sides of the pixel pair of interest and symmetrically with respect to the pixel pair of interest, are taken as the even number of the pixels that are at least four pixels and are adjacent in series to one another in the image,
the two pixels, which constitute each of the six pixel pairs of interest, are taken as the two middle pixels, which are among the even number of the pixels that are adjacent in series to one another in the image, and
a judgment is made as to whether an edge is or is not located between the two pixels, which constitute each of the six pixel pairs of interest.

25. A computer program as defined in claim 24 wherein the computer program further comprises the procedure for operating such that:
in cases where an edge has been detected between the two pixels, which constitute one of the six pixel pairs of interest,
an edge pattern within an area of the array of the four adjacent pixels in the image, the four adjacent pixels being arrayed in the form of 2×2 pixels, is classified in accordance with a position at which the edge has been detected.

26. A computer program as defined in claim 22 wherein the procedure for performing the judgment processing is a procedure for operating such that:
in cases where a judgment is to be made as to whether an edge is or is not located between two pixels, which are adjacent to each other and constitute each of six pixel pairs of interest in an array of four adjacent pixels in an image, the four adjacent pixels being arrayed in a form of 2×2 pixels,
an even number of pixels that are at least four pixels, which contain the two pixels constituting each of the six pixel pairs of interest in the array of the four adjacent pixels in the image, and which contain pixels adjacent in series to the pixel pair of interest on opposite sides of the pixel pair of interest and symmetrically with respect to the pixel pair of interest, are taken as the even number of the pixels that are at least four pixels and are adjacent in series to one another in the image,
the two pixels, which constitute each of the six pixel pairs of interest, are taken as the two middle pixels, which are among the even number of the pixels that are adjacent in series to one another in the image, and
a judgment is made as to whether an edge is or is not located between the two pixels, which constitute each of the six pixel pairs of interest.

27. A computer program as defined in claim 26 wherein the computer program further comprises the procedure for operating such that:
in cases where an edge has been detected between the two pixels, which constitute one of the six pixel pairs of interest,
an edge pattern within an area of the array of the four adjacent pixels in the image, the four adjacent pixels being arrayed in the form of 2×2 pixels, is classified in accordance with a position at which the edge has been detected.

28. A computer readable recording medium, on which a computer program for causing a computer to execute an image interpolation method for interpolating a new pixel between pixels in an image at the time of image size enlargement or reduction processing has been recorded and from which the computer is capable of reading the computer program,
wherein the computer program comprises the procedures for:
i) operating such that, in cases where it has been detected that an edge is located between the pixels, between which the new pixel is to be interpolated, a predetermined boundary is set between the pixels, between which the new pixel is to be interpolated,
ii) making a judgment as to whether a position of the new pixel to be interpolated is located on one side of the predetermined boundary or is located on the other side of the predetermined boundary, and
iii) performing an interpolating operation such that:
a) in cases where it has been judged that the position of the new pixel is located on the one side of the predetermined boundary,
the interpolating operation is performed by use of a pixel value of at least one pixel, which is located on the one side of the predetermined boundary in the image, in order to calculate a pixel value of the new pixel, and
b) in cases where it has been judged that the position of the new pixel is located on the other side of the predetermined boundary,
the interpolating operation is performed by use of the pixel value of at least one pixel, which is located on the other side of the predetermined boundary in the image, in order to calculate a pixel value of the new pixel.

29. A computer readable recording medium as defined in claim 28 wherein the predetermined boundary is a line bisecting the distance between the pixels, between which the new pixel is to be interpolated.

30. A computer readable recording medium, on which a computer program for causing a computer to execute an edge detecting method has been recorded and from which the computer is capable of reading the computer program,
wherein the computer program comprises the procedures for:
i) performing filtering processing with a difference filter and on each of pixel pairs, each of the pixel pairs being constituted of two pixels, which are adjacent to each other and are contained in an even number of pixels that are at least four pixels and are adjacent in series to one another in an image, a difference between pixel values of the two pixels, which are adjacent to each other and constitute each of the pixel pairs, being obtained from the filtering processing, a plurality of differences being obtained for the pixel pairs, and
ii) performing judgment processing such that:
a) a judgment is made as to whether an absolute value of the difference between the pixel values of the pixel pair constituted of two middle pixels, which are among the even number of the pixels that are adjacent in series to one another in the image, is or is not a maximum value among the absolute values of the differences having been obtained for all of the pixel pairs, and
b) in cases where it has been judged that the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs,
it is judged that an edge is located between the two middle pixels, which are among the even number of the pixels that are adjacent in series to one another in the image.

31. A computer readable recording medium, on which a computer program for causing a computer to execute an edge detecting method has been recorded and from which the computer is capable of reading the computer program,
wherein the computer program comprises the procedures for:
i) performing filtering processing with a difference filter and on each of pixel pairs, each of the pixel pairs being constituted of two pixels, which are adjacent to each other and are contained in an even number of pixels that are at least four pixels and are adjacent in series to one another in an image, a difference between pixel values of the two pixels, which are adjacent to each other and constitute each of the pixel pairs, being obtained from the filtering processing, a plurality of differences being obtained for the pixel pairs, and
ii) performing judgment processing such that:
a) a judgment is made as to whether an absolute value of the difference between the pixel values of the pixel pair constituted of two middle pixels, which are among the even number of the pixels that are adjacent in series to one another in the image, is or is not equal to at least a predetermined threshold value, and
b) in cases where it has been judged that the absolute value of the difference between the pixel values of the pixel pair constituted of the two middle pixels, which are among the even number of the pixels that are adjacent in series to one another in the image, is equal to at least the predetermined threshold value,
it is judged that an edge is located between the two middle pixels, which are among the even number of the pixels that are adjacent in series to one another in the image.

32. A computer readable recording medium as defined in claim 31 wherein the procedure for performing the judgment processing is a procedure for operating such that:
a) in cases where it has been judged that the absolute value of the difference between the pixel values of the pixel pair constituted of the two middle pixels, which are among the even number of the pixels that are adjacent in series to one another in the image, is not equal to at least the predetermined threshold value,
a judgment is made as to whether or not the absolute value of the difference between the pixel values of the pixel pair constituted of the two middle pixels, which are among the even number of the pixels that are adjacent in series to one another in the image, is equal to at least a threshold value, which is smaller than the predetermined threshold value, and at the same time the absolute value of the difference between the pixel values of the pixel pair constituted of the two middle pixels, which are among the even number of the pixels that are adjacent in series to one another in the image, is a maximum value among the absolute values of the differences having been obtained for all of the pixel pairs, and
b) in cases where it has been judged that the absolute value of the difference between the pixel values of the pixel pair constituted of the two middle pixels, which are among the even number of the pixels that are adjacent in series to one another in the image, is equal to at least the threshold value, which is smaller than the predetermined threshold value, and at the same time the absolute value of the difference between the pixel values of the pixel pair constituted of the two middle pixels, which are among the even number of the pixels that are adjacent in series to one another in the image, is the maximum value among the absolute values of the differences having been obtained for all of the pixel pairs,
it is judged that an edge is located between the two middle pixels, which are among the even number of the pixels that are adjacent in series to one another in the image.

33. A computer readable recording medium as defined in claim 30 wherein the procedure for performing the judgment processing is a procedure for operating such that:
in cases where a judgment is to be made as to whether an edge is or is not located between two pixels, which are adjacent to each other and constitute each of six pixel pairs of interest in an array of four adjacent pixels in an image, the four adjacent pixels being arrayed in a form of 2×2 pixels,
an even number of pixels that are at least four pixels, which contain the two pixels constituting each of the six pixel pairs of interest in the array of the four adjacent pixels in the image, and which contain pixels adjacent in series to the pixel pair of interest on opposite sides of the pixel pair of interest and symmetrically with respect to the pixel pair of interest, are taken as the even number of the pixels that are at least four pixels and are adjacent in series to one another in the image,
the two pixels, which constitute each of the six pixel pairs of interest, are taken as the two middle pixels, which are among the even number of the pixels that are adjacent in series to one another in the image, and
a judgment is made as to whether an edge is or is not located between the two pixels, which constitute each of the six pixel pairs of interest.

34. A computer readable recording medium as defined in claim 33 wherein the computer program further comprises the procedure for operating such that:
in cases where an edge has been detected between the two pixels, which constitute one of the six pixel pairs of interest,
an edge pattern within an area of the array of the four adjacent pixels in the image, the four adjacent pixels being arrayed in the form of 2×2 pixels, is classified in accordance with a position at which the edge has been detected.

35. A computer readable recording medium as defined in claim 31 wherein the procedure for performing the judgment processing is a procedure for operating such that:
in cases where a judgment is to be made as to whether an edge is or is not located between two pixels, which are adjacent to each other and constitute each of six pixel pairs of interest in an array of four adjacent pixels in an image, the four adjacent pixels being arrayed in a form of 2×2 pixels,
an even number of pixels that are at least four pixels, which contain the two pixels constituting each of the six pixel pairs of interest in the array of the four adjacent pixels in the image, and which contain pixels adjacent in series to the pixel pair of interest on opposite sides of the pixel pair of interest and symmetrically with respect to the pixel pair of interest, are taken as the even number of the pixels that are at least four pixels and are adjacent in series to one another in the image,
the two pixels, which constitute each of the six pixel pairs of interest, are taken as the two middle pixels, which are among the even number of the pixels that are adjacent in series to one another in the image, and
a judgment is made as to whether an edge is or is not located between the two pixels, which constitute each of the six pixel pairs of interest.

36. A computer readable recording medium as defined in claim 35 wherein the computer program further comprises the procedure for operating such that:
in cases where an edge has been detected between the two pixels, which constitute one of the six pixel pairs of interest,
an edge pattern within an area of the array of the four adjacent pixels in the image, the four adjacent pixels being arrayed in the form of 2×2 pixels, is classified in accordance with a position at which the edge has been detected.
